(19) United States
(12) Patent Application Publication
(10) Pub. No.: US 2016/0239649 A1
(43) Pub. Date: Aug. 18, 2016

(54) CONTINUOUS AUTHENTICATION

(71) Applicant: QUALCOMM Incorporated, San Diego, CA (US)

(72) Inventor: Haijun ZHAO, Beijing (CN)

(21) Appl. No.: 14/622,533

(22) Filed: Feb. 13, 2015

(51) Int. Cl. G06F 21/31

(52) U.S. Cl. CPC G06F 21/316

(57) ABSTRACT

Techniques for implementing continuous authentication of a mobile device user in a mobile device are provided. These techniques include a method that includes collecting behavioral information of the mobile device user during a continuous authentication session, analyzing the behavioral information to determine a score, generating a confidence level value based on the score, and determining that the mobile device user is an authorized user of the mobile device based on the generated confidence level value.

### BACKGROUND

Static authentication methods authenticate a user of a mobile device once for a particular time period based on static authentication information input by the mobile device user. For example, the mobile device user may input a password to validate their identity as an authorized user of the mobile device and to unlock the mobile device. Once authenticated, the authorized user may operate the mobile device with unrestricted access to software applications and/or stored information. The static authentication methods may not detect a change of user after validation. This may inconveniently interrupt user interaction with the mobile device. For example, if the authenticated user leaves the mobile device in a public place and forgets to lock the mobile device, another user can access information on the unlocked device. The other user may be an unauthorized user of the mobile device, for example, an attacker or a malicious user. Detecting if the user of the device changes from the authenticated and authorized user to a different user based on static authentication methods typically requires re-entry of the static authentication information. Even if the authorized user locks the device, the malicious user may leverage operating system (OS) flaws to bypass the lock screen. Static authentication methods typically use simple score/threshold models to detect the unauthorized user. In a simple score/threshold model, a score characterizing user behavior is compared to a score threshold. The unauthorized user is detected by the score crossing the score threshold. A relatively small deviation in behavior by the authorized user may cause false rejections of the authorized user according to the simple score/threshold model. For example, if the small deviation in user behavior causes the score to cross the threshold, the authorized user may be considered to be the unauthorized user and may be locked out of the device unnecessarily. Static authentication methods for validating the authorized user's identity may be insufficient for modern devices and applications that process sensitive data.

### SUMMARY

An example method of implementing continuous authentication of a mobile device user in a mobile device includes collecting behavioral information of the mobile device user during a continuous authentication session, analyzing the behavioral information to determine a score, generating a confidence level value based on the score, and determining that the mobile device user is an authorized user of the mobile device based on the generated confidence level value.

Implementations of such a method may include one or more of the following features. The method may include collecting the behavioral information in a non-secure world of a trusted execution environment (TEE), passing the behavioral information from the non-secure world of the TEE to a secure world of the TEE, and analyzing the behavioral information in the secure world of the TEE. The method may include collecting application identification information for a particular application corresponding to the behavioral information and passing the application identification information for the particular application from the non-secure world of the TEE to the secure world of the TEE, wherein the analyzing the behavioral information further includes analyzing the behavioral information corresponding to the particular application. The behavioral information may include touch information. Generating the confidence level value based on the score may include comparing the score to a score threshold value and generating the confidence level value by increasing or decreasing, as determined by the comparison, a previously determined confidence level. Analyzing the behavioral information to determine the score may include classifying the behavioral information, extracting features of the classified behavioral information, storing the extracted features in an authentication template, determining an authentication template vector based on the authentication template, and determining the score wherein the score is an inter-vector distance between the authentication template vector and a baseline template vector, the baseline template vector being determined from a previously stored baseline template. The method may include determining that the mobile device user is the authorized user of the mobile device based on the generated confidence level value being less than or equal to a confidence level threshold, determining that the mobile device user is an unauthorized user of the mobile device based on the generated confidence level value being greater than the confidence level threshold, and, in response to determining that the mobile device user is the unauthorized user of the mobile device, discontinuing the continuous authentication session and restricting access to the mobile device. The method may include initializing the confidence level value at a commencement of the continuous authentication session and generating the confidence level value may include updating the confidence level value. The method may include receiving static authentication information, and, in response to receiving the static authentication information, automatically commencing the continuous authentication session.

An example of a mobile device according to the disclosure includes a processor configured to collect behavioral information of a mobile device user during a continuous authentication session, analyze the behavioral information to determine a score and to generate a confidence level value based on the score, and determine that the mobile device user is an authorized user of the mobile device based on the generated confidence level value.

Implementations of such a mobile device may include one or more of the following features. The processor may be configured to collect the behavioral information in a non-secure world of a trusted execution environment (TEE), collect application identification information for a particular application corresponding to the behavioral information, pass the behavioral information and the application identification information for the particular application from the non-secure world of the TEE to a secure world of the TEE, and analyze the behavioral information, corresponding to the application identification information for the particular application, in the secure world of the TEE. The behavioral information may include touch information. The processor configured to analyze the behavioral information may be further configured to classify the behavioral information, extract features of the classified behavioral information, store the extracted features in an authentication template, determine an authentication template vector based on the authentication template, determine the score wherein the score is an inter-vector distance between the authentication template vector and a baseline template vector, the baseline template vector being determined from a previously stored baseline template, compare the score to a score threshold value, and generate the confidence level value by increasing or decreasing, as determined by the comparison, a previously determined confidence level value. The processor may be configured to determine that the mobile device user is the authorized user of the mobile device based on the generated confidence level value being less than or equal to a confidence level threshold, determine that the mobile device user is an unauthorized user of the mobile device based on the generated confidence level value being greater than the confidence level threshold, and, in response to the determination that the mobile device user is the unauthorized user of the mobile device, discontinue the continuous authentication session and restrict access to the mobile device. The processor may be configured to initialize the confidence level value at a commencement of the continuous authentication session and, the processor configured to analyze the behavioral information to generate the confidence level value may be configured to analyze the behavioral information to update the confidence level value. The processor may be configured to receive static authentication information and automatically commence the continuous authentication session in response to receiving the static authentication information.

An example of a non-transitory, computer-readable medium, having stored thereon computer-readable instructions for implementing continuous authentication of a mobile device user in a mobile device includes instructions configured to cause the mobile device to collect behavioral information of the mobile device user during a continuous authentication session, analyze the behavioral information to determine a score and to generate a confidence level value based on the score, and determine that the mobile device user is an authorized user of the mobile device based on the generated confidence level value.

Implementations of such a non-transitory, computer-readable medium may include one or more of the following features. The instructions may include instructions configured to cause the mobile device to collect the behavioral information in a non-secure world of a trusted execution environment (TEE), collect application identification information for a particular application corresponding to the behavioral information, pass the behavioral information and the application identification information for the particular application from the non-secure world of the TEE to a secure world of the TEE, and analyze the behavioral information, corresponding to the application identification information for the particular application, in the secure world of the TEE. The behavioral information may include touch information. The instructions configured to cause the mobile device to analyze the behavioral information may include instructions configured to cause the mobile device to classify the behavioral information, extract features of the classified behavioral information, store the extracted features in an authentication template, determine an authentication template vector based on the authentication template, determine the score wherein the score is an inter-vector distance between the authentication template vector and a baseline template vector, the baseline template vector being determined from a previously stored baseline template, compare the score to a score threshold value, and generate the confidence level value by increasing or decreasing, as determined by the comparison, a previously determined confidence level value. The instructions may include instructions configured to cause the mobile device to determine that the mobile device user is the authorized user of the mobile device based on the generated confidence level value being less than or equal to a confidence level threshold, determine that the mobile device user is an unauthorized user of the mobile device based on the generated confidence level value being greater than the confidence level threshold, and, in response to the determination that the mobile device user is the unauthorized user of the mobile device, discontinue the continuous authentication session and restrict access to the mobile device. The instructions may include instructions configured to cause the mobile device to initialize the confidence level value at a commencement of the continuous authentication session and the instructions configured to cause the mobile device to analyze the behavioral information to generate the confidence level value may be further configured to cause the mobile device to analyze the behavioral information to update the confidence level value. The instructions may include instructions configured to cause the mobile device to receive static authentication information and automatically commence the continuous authentication session in response to receiving the static authentication information.

An example of a mobile device according to the disclosure may include means for collecting behavioral information of a mobile device user during a continuous authentication session, means for analyzing the behavioral information to determine a score and to generate a confidence level value based on the score, and means for determining that the mobile device user is an authorized user of the mobile device based on the generated confidence level value.

Implementations of such a mobile device may include one or more of the following features. The mobile device may include means for collecting the behavioral information in a non-secure world of a trusted execution environment (TEE), means for collecting application identification information for a particular application corresponding to the behavioral information, means for passing the behavioral information and the application identification information for the particular application from the non-secure world of the TEE to a secure world of the TEE, and means for analyzing the behavioral information, corresponding to the application identification information for the particular application, in the secure world of the TEE. The behavioral information may include touch information. The means for analyzing the behavioral information may further include means for classifying the behavioral information, means for extracting features of the classified behavioral information, means for storing the extracted features in an authentication template, means for determining an authentication template vector based on the authentication template, means for determining the score wherein the score is an inter-vector distance between the authentication template vector and a baseline template vector, the baseline template vector being determined from a previously stored baseline template, means for comparing the score to a score threshold value, and means for generating the confidence level value by increasing or decreasing, as determined by the comparison, a previously determined confidence level. The mobile device may include means for determining that the mobile device user is the authorized user of the mobile device based on the generated confidence level value being less than or equal to a confidence level threshold, means for determining that the mobile device user is an unauthorized user of the mobile device based on the generated confidence level value being greater than the confidence level threshold, and means for, in response to determining that the mobile device user is the unauthorized user of the mobile device, discontinuing the continuous authentication session and restricting access to the mobile device. The mobile device may include means for initializing the confidence level value at a commencement of the continuous authentication session and the means for analyzing the behavioral information to generate the confidence level value may include means for analyzing the behavioral information to update the confidence level value. The mobile device may include means for receiving static authentication information and means for, in response to receiving the static authentication information, automatically commencing the continuous authentication session.

Items and/or techniques described herein may provide one or more of the following capabilities. A continuous authentication module may be implemented in a mobile device. The continuous authentication module may collect and analyze touch screen information. The continuation authentication module may continuously execute collection and analysis procedures as background processes without interruption of normal mobile device operations. The analyzed touch screen information may be used to determine a user specific and application specific score indicative of an inter-vector distance between an authentication template vector and a baseline template vector. The touch screen information analysis may be performed in a trusted execution environment. The score may be used with a penalty and reward function to determine a confidence level value. The confidence level value may be used to detect an unauthorized user and authenticate an authorized user of the mobile device. Other capabilities may be provided and not every implementation according to the disclosure must provide any, let alone all, of the capabilities discussed. Further, it may be possible for an effect noted above to be achieved by means other than that noted and a noted item/technique may not necessarily yield the noted effect.

### BRIEF DESCRIPTIONS OF THE DRAWINGS

FIG. 1 is a schematic diagram of an example of a mobile device system.

FIG. 2 is a block diagram of hardware components of the mobile device shown in FIG. 1.

FIGS. 3A and 3B are illustrations of examples of touch information.

FIG. 4 is a block diagram of software architecture for implementing continuous authentication.

FIGS. 5A, 5B, and 6 are illustrations of examples of classified touch information.

FIG. 7 is an illustration of examples of statistical distributions of an extracted feature for different users.

FIG. 8 is a graph of the confidence value versus elapsed continuous authentication session time according to a penalty and reward function.

FIG. 9 is a block diagram of a method of implementing continuous authentication of a mobile device user.

FIG. 10 is a block diagram of a method of generating a baseline template.

### DETAILED DESCRIPTION

Techniques are provided for implementing continuous authentication procedures in a mobile device. As compared to static authentication procedures, continuous authentication procedures may be more effective in protecting a system, like the mobile device, from malicious user access after an authorized user has unlocked and accessed the mobile device via static authentication.

A continuous authentication procedure monitors identification information associated with the authorized user and runs continuously as a background, or daemon, process in order to gather and analyze the identification information in a manner transparent to the user and without interruption of the user's interactions with the mobile device. The identification information enables a continuous authentication module executing the continuous authentication procedure to discriminate between different users and discern whether or not the mobile device user is the authorized user or an unauthorized user. As the mobile device is used, the continuous authentication procedure executing in the background of the normal mobile device operations can detect a change from the authorized user to an unauthorized user. As used herein, the authorized user refers to one or more users of the mobile device associated with and identified by the static authentication information and/or a baseline template generated from behavioral enrollment information. As used herein, an unauthorized user refers to one or more users of the mobile device not associated with nor identified by the static authentication information and/or the baseline template generated from behavioral enrollment information.

The identification information is behavioral information collected from one or more primary input devices of the mobile device. The one or more primary input devices enable the mobile device user to input commands or information during routine mobile device operation. For example, the behavioral information may be touch information collected during user interactions with a touch screen as the primary input device of the mobile device. In general, the touch information is analyzed to characterize and quantify the interactions between the mobile device user and the touch screen. Finger interactions, gesture interactions, and hand interactions are examples of touch screen interactions that generate the touch information. Analysis of the touch information generates a baseline touch profile, or template, and an authentication touch profile, or template, that are specific to a particular mobile device user that is the authorized user. Comparison of the baseline template and the authentication template determines a score indicative of an inter-vector distance between an authentication template vector and a baseline template vector. A penalty and reward function may be used to determine a confidence level value based on the score and a score threshold. The confidence level value indicates the likelihood that a previously authenticated user is in control of the mobile device and has not changed to the unauthorized user. A change in a confidence level value for current touch behavior from a confidence level value for previous touch behavior may detect a change in the identity of the mobile device user. The confidence level value typically increases and decreases as the touch information is collected and analyzed. However, a change in the confidence level value that increases the confidence level value above a confidence level threshold indicates the change in identity of the mobile device user.

The continuous authentication methods described herein may provide several advantages. Collection of the behavioral information from the one or more primary input devices may provide cost and battery life advantages. For example, collection of biometric information, like fingerprints, facial thermograms, facial images, hand geometry, iris and/or retina scans, voice characteristics, palm prints, gait information, etc., require operation of secondary input devices such as mobile device hardware or sensors specifically designed to gather each type of biometric information. Operating the specialized sensors may adversely affect the mobile device battery life. The mobile device battery is designed to support continuous operation of the one or more primary input devices but continuous operation of the secondary input device may dramatically reduce the battery life of the mobile device. The continuous authentication procedures described herein further provide ease of use and security advantages, for example, as compared to static authentication methods. As discussed above, the continuous authentication methods do not require the mobile device user to interrupt mobile device usage and re-enter a password in order to re-confirm his/her identity. Additionally, continuous authentication methods enable ongoing improvements of authentication accuracy and device security because the continuous authentication methods execute in real-time as the device is used. As an amount of collected touch information increases over a time period of device usage, a statistical accuracy of user identification improves and enables dynamic adjustment of authentication thresholds. Security advantages also may be realized via the implementation of the continuous authentication methods in a trusted execution environment (TEE). The TEE provides enhanced security for the user specific authentication information and the continuous authentication methods used to detect the unauthorized user.

The techniques discussed below are examples and not limiting as other implementations in accordance with the disclosure are possible. Individual ones of the described techniques may be implemented as a method, apparatus, or system and can be embodied in computer-readable media.

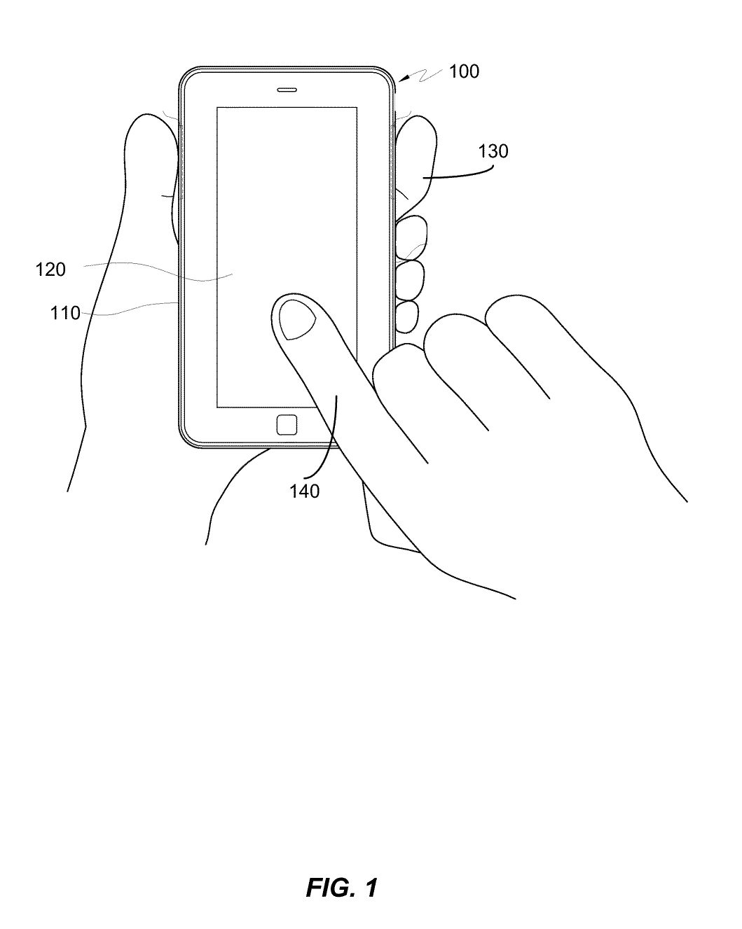

Referring to FIG. 1, a schematic diagram of an example of a mobile device system 100 is shown. The mobile device system 100 includes a mobile device 110 equipped with a touch screen 120. Although shown as a handheld mobile phone in FIG. 1, the mobile device 110 may be another electronic device that may be moved about by a user. The mobile device 110 may also be referred to as a mobile station or a user equipment, and examples of the mobile device 110 include, but are not limited to, a mobile phone, a smartphone, a netbook, a laptop computer, a tablet or slate computer, an entertainment appliance, a navigation device, and/or combinations thereof Claimed subject matter is not limited to a particular type, category, size, etc., of mobile device. During operation of the mobile device 110, a touch input element 140 may interact with the touch screen 120. The touch input element 140 may include one or more fingers, hands, and/or other body parts of the user and/or a stylus, pen, or other touch device gripped by the user or otherwise brought into contact and/or proximity to the touch screen 120. The mobile device 110 may be held in one hand 130 of the user or may be held bimanually.

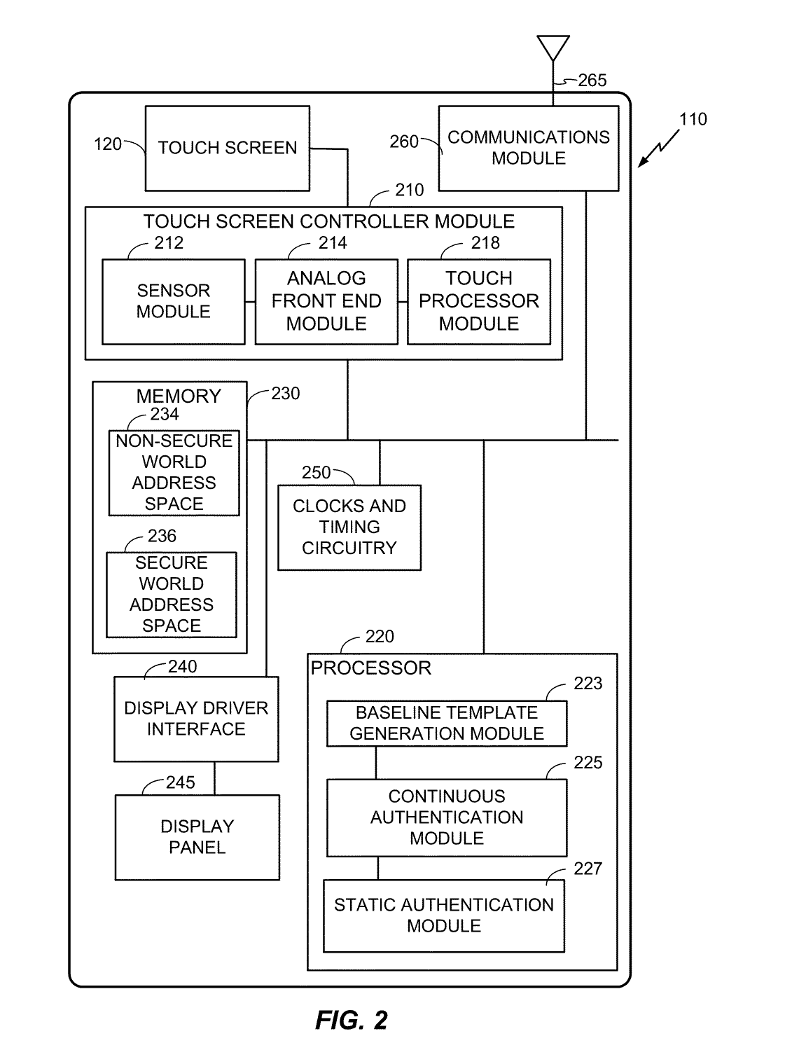

Referring to FIG. 2, with further reference to FIG. 1, a block diagram of hardware components of the mobile device 110 is shown. A quantity of each component in FIG. 2 is an example only and other quantities of each, or any, component could be used. The hardware components include the touch screen 120, a touch screen controller module 210, a processor 220, a memory 230, a display driver interface 240, a display panel 245, clocks and timing circuitry 250, and a communications module 260. The touch screen controller module 210, the processor 220, the memory 230, the display driver interface 240, and the clocks and timing circuitry 250 may be discrete components or integrated components and/or may be components of a system-on-chip (SoC), or a combination thereof.

The communications module 260 is configured to enable the mobile device 110 to send and receive wireless signals via a wireless antenna 265 over one or more communications networks. Examples of such communications networks include but are not limited to a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMax, Ultra Mobile Broadband (UMB), and/or the like. The communications module 260 is further configured to enable the mobile device 110 to communicate and exchange information, including but not limited to location information, either directly or indirectly with other communications network entities, including but not limited to, access points, base stations, navigation servers, location servers, other mobile devices, etc. The communications module 260 may also be configured to enable the mobile device 110 to receive navigation signals that the mobile device 110 may use to determine the location information. For example, the communications module 260 may be configured to receive signals from satellite vehicles (SVs) belonging to one or more Satellite Positioning Systems (SPSs), such as the GPS system, the GLONASS system, the Galileo system, and/or other SPSs.

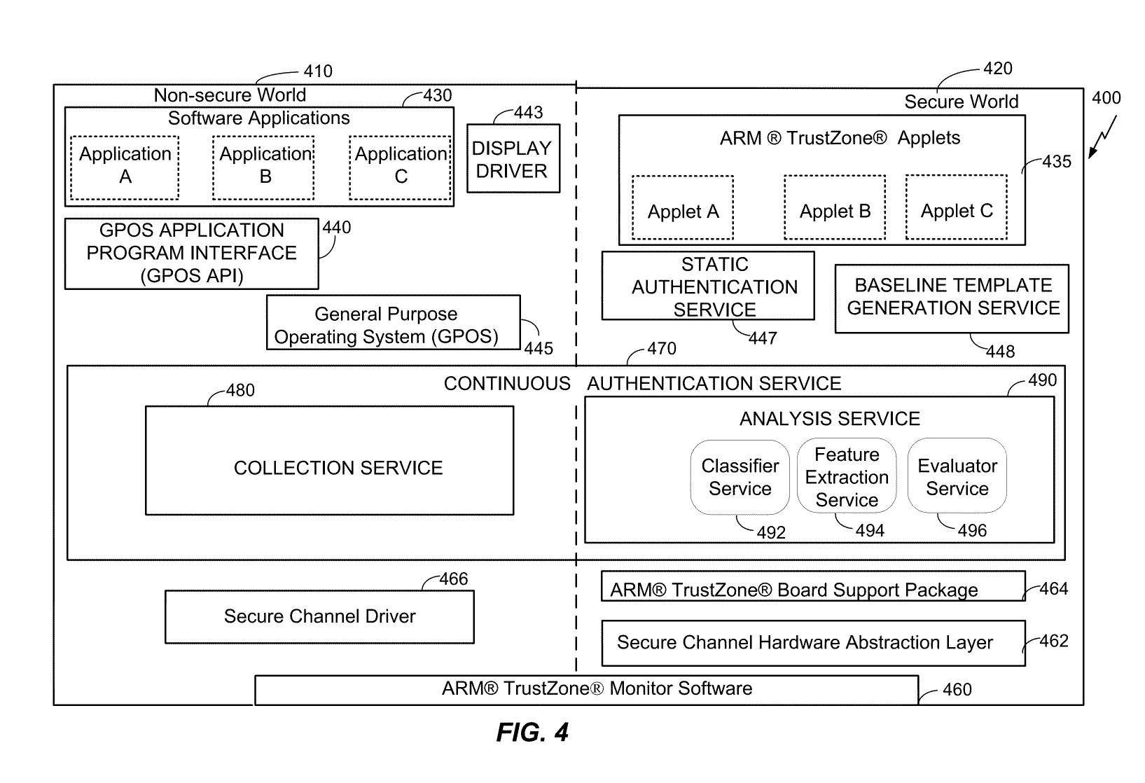

The processor 220 is a physical processor (i.e., an integrated circuit configured to execute operations on the mobile device 110 as specified by software and/or firmware). The processor 220 may be an intelligent hardware device, e.g., a central processing unit (CPU), one or more microprocessors, a controller or microcontroller, an application specific integrated circuit (ASIC), a general-purpose processor, a digital signal processor (DSP), a field programmable gate array (FPGA) or other programmable logic device, a state machine, discrete gate or transistor logic, discrete hardware components, or any combination thereof designed to perform the functions described herein and operable to carry out instructions on the mobile device 110. The processor 220 may also be implemented as a combination of computing devices, e.g., a combination of DSP and a microprocessor, a plurality of microprocessors, one or more microprocessors in conjunction with a DSP core, or any other such configuration. The processor 220 may include multiple separate physical entities that may be distributed in the mobile device 110. The processor 220 is communicatively coupled to the touch screen controller module 210, the touch screen 120, the memory 230, the display driver interface 240, the display panel 245, and the clocks and timing circuitry 250. The processor 220 either alone, or in combination with the memory 230, provides means for performing functions as described herein, for example, executing code or instructions stored in the memory 230, specifically various code or instructions discussed below with regard to FIG. 4.

The processor 220 may include a baseline template generation module 223, a continuous authentication module 225, and a static authentication module 227. The continuous authentication module (CA module) 225, the static authentication module 227, and the baseline template generation module 223 are communicatively coupled to one another and to the memory 230. The baseline template generation module 223 may execute instructions of a baseline template generation service 448, as described in more detail below with regard to FIG. 4. Either alone, or in combination with the memory 230, the baseline template generation module 223 provides means for performing functions as described herein (e.g., means for collecting baseline template information, classifying baseline template information, extracting features, generating a baseline template). The CA module 225 may execute instructions of a continuous authentication service 470 (i.e., CA service 470), as described in more detail below with regard to FIG. 4. Either alone, or in combination with the memory 230, the CA module 225 provides means for performing functions as described herein (e.g., means for performing the functions described below with regard to FIG. 4 including collecting behavioral information, analyzing behavioral information, generating a confidence level value, collecting application identification information for a particular application, determining that a mobile device user is an authorized user or an unauthorized user of the mobile device, passing behavioral information, determining and comparing a score, collecting application identification information, classifying behavioral information, extracting features, storing extracted features, determining an authentication template vector, commencing and discontinuing a continuous authentication session, initializing a confidence level value, and/or updating a confidence level value). The static authentication module 227 may execute instructions of a static authentication service 447, as described in more detail below with regard to FIG. 4. Either alone, or in combination with the memory 230, the static authentication module 227 provides means for performing functions as described herein (e.g., means for receiving and sending static authentication information). The baseline template generation module 223, the CA module 225, and the static authentication module 227 are illustrated as discrete modules for clarity with regard to functions performed by these modules and not limiting of the claimed subject matter.

The memory 230 refers generally to any type of computer storage medium, including but not limited to RAM, ROM, FLASH, disc drives, etc. The memory 230 may be long term, short term, or other memory associated with the mobile device 110 and is not to be limited to any particular type of memory or number of memories, or type of media upon which memory is stored. The memory 230 is a non-transitory, processor-readable storage medium that stores processor-readable, processor-executable software code containing instructions that are configured to, when executed, cause the processor 220 to perform various functions described herein (although the description may refer only to the processor 220 performing the functions). Alternatively, the software code may not be directly executable by the processor 220 but configured to cause the processor 220, e.g., when compiled and executed, to perform the functions. In particular, the instructions or code may include one or more components of software architecture discussed below in more detail with regard to FIG. 4. The memory 230 may further provide storage of information determined by the touch screen controller module 210 and/or the processor 220.

The display driver interface 240 is configured to control the display panel 245 according to instructions received from the processor 220. The display panel 245 may be any output device that displays information to the user. Examples may include a liquid crystal display screen, cathode ray tube monitor, seven-segment display, etc. In an example, the touch screen 120 may be a primary input device for the mobile device 110. In other examples, the primary input device may be a pointing device (such as a mouse, trackball, stylus, etc.), a keyboard, a microphone or other voice input device, a joystick, a camera, etc., or a combination thereof (e.g., a keyboard and a mouse). The touch screen 120 may be coextensive with the mobile device 110 and/or the display panel 245 (for example, as shown in FIG. 1). In such a configuration, the touch screen 120 and the display panel 245 may form a single device that provides both input and output capabilities. In an example, the touch screen 120 may be an input device physically separate from the mobile device 110 and/or the display panel 245 but communicatively coupled to the mobile device 110 and the display panel 245 and located nearby to allow the user who touches the touch screen 120 to control the mobile device 110 and view the display panel 245. The touch screen 120 may include, but is not limited to, a capacitive-type touch screen, a resistive-type touch screen, an acoustic wave-type touch screen, an infrared-type touch screen, etc.

The touch screen 120 is coupled to the touch screen controller module 210. In FIG. 2, the touch screen controller module 210 is illustrated separately from the processor 220 for clarity. However, the touch screen controller module 210 may be part of processor 220 or may be implemented in the processor 220 based on instructions stored in memory 230 and implemented by processor 220. The touch screen controller module 210 includes a sensor module 212, an analog front end module 214, and a touch processor module 218. The sensor module 212 senses contact and/or proximity (i.e., nearness to the touch screen 120) of the touch input element 140 based on an effect on a property of the touch screen 120 in response to the contact and/or proximity of the touch input element 140. Further, the sensor module 212 measures the effect on the property associated with the particular type of touch screen 120. For example, for the capacitive-type touch screen, the sensor module 212 may measure a change in capacitance across touch screen electrodes (not shown) in response to a finger contact. Based on the type of touch screen, other measured properties may include voltage, pressure, acoustic wave absorption, infrared light absorption, etc. The sensor module 212 provides an analog signal corresponding to the measured effect to an analog front end module 214. The analog front end module 214 receives the analog signal, for example, the measured capacitance, and converts the analog signal to a digital signal. The analog front end module 214 may include row/column drivers (not shown) and an analog-to-digital converter (not shown). The row/column drivers may associate the analog signal with a location on the touch screen 120. The analog front end module 214 may also receive a timing signal from the clocks and timing circuitry 250. The analog front end module 214 provides the digital signal corresponding to the measured property and location and/or the timing signal to the touch processor module 218. The touch processor module 218 receives and processes the digital signal and/or the timing signal from the analog front end module 214 to determine touch information.

In some implementations, the touch screen controller module 210 may be a general primary input device controller module corresponding to the particular type of primary input device (e.g., the pointing device, the keyboard, the voice input device, the joystick, the camera, etc., or a combination thereof). In such implementations, the primary input device controller module may sense analog signals generated by user interaction with the primary input device, convert these analog signals to digital signals, and process the digital signals to determine behavioral information corresponding to the particular primary input device. As examples, the behavioral information may include mouse usage characteristics, keystroke information, voice characteristics, facial characteristics, etc. as determined by the type of primary input device.

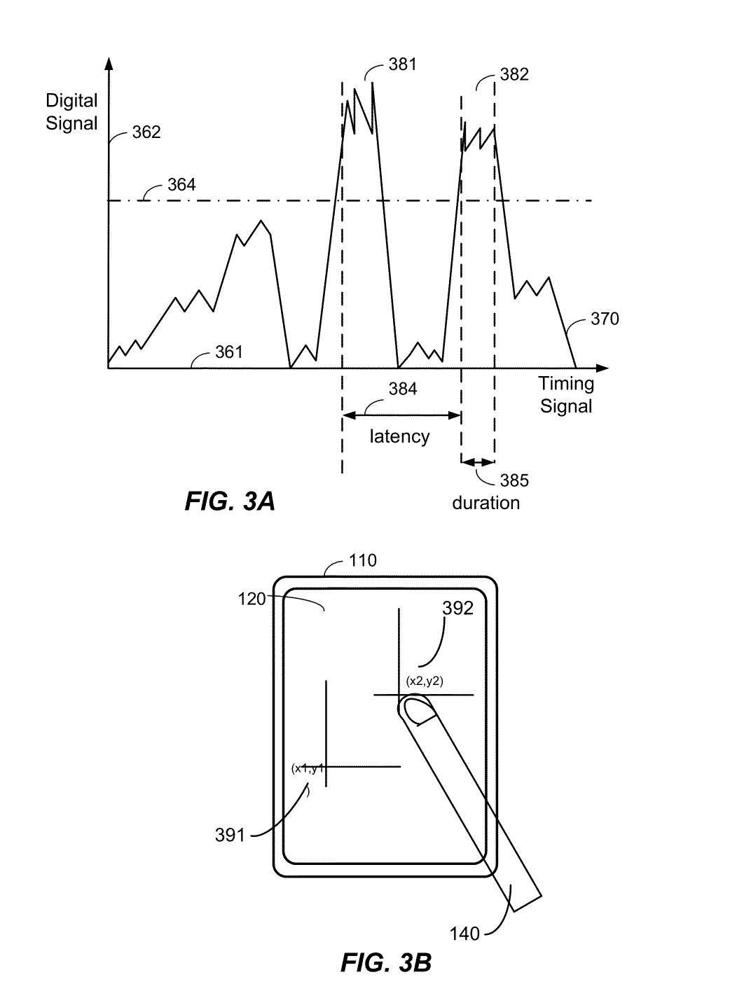

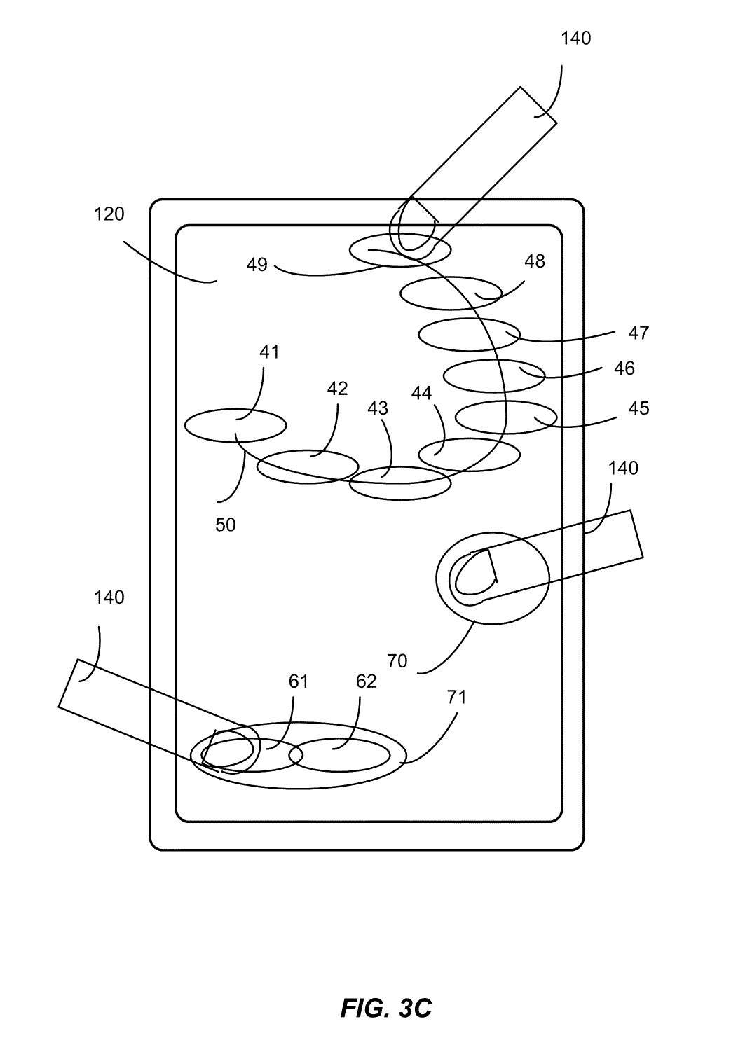

Referring to FIGS. 3A and 3B, illustrations of examples of the touch information are shown. An example of a digital signal graph 370 corresponding to the measured property as a function of time is shown in FIG. 3A (i.e., the digital signal along a vertical axis 362 and the timing signal along a horizontal axis 361). A digital signal threshold 364 may identify a first touch event 381 and a second touch event 382. Signals below the digital signal threshold 364 may correspond to noise whereas signals above the digital signal threshold 364 may correspond to the touch events. Each touch event is in response to an interaction (e.g., contact and/or proximity of the touch input element 140 to the touch screen 120). Further, each touch event may correspond to a set of touch information. The touch information may include touch screen coordinates, temporal information, stroke information, touch area, and pressure associated with the touch event. For example, the touch processor module 218 may determine horizontal and vertical coordinates corresponding to each touch event (e.g., coordinates (x1, y1) 391 may correspond to the first touch event 381 and coordinates (x2, y2) 392 may correspond to the second touch event 382). The touch processor module 218 may additionally determine temporal information for the touch events such as a latency 384 and a duration 385. The latency 384 is an elapsed time between touch events and the duration 385 is the elapsed time of a single touch event. Referring to FIG. 3B, the set of touch information may further include a stroke or a touch area. For example, the touch processor module 218 may fit a curve 50 to a set of touch events 41, 42, 43, 44, 45, 46, 47, 48, 49 to define the stroke. The touch processor module 218 may determine a speed and/or a direction associated with the stroke. As another example, the touch processor module 218 may determine a touch area 70 associated with one touch event or a touch area 71 with a set of touch events 61, 62. The above examples of touch information are not limiting of the claimed subject matter and other types of touch information may be available as supported by a particular touch screen technology and the set of touch information may further include a touch pressure.

Referring to FIG. 4, with further reference to FIGS. 1-3, a block diagram of software architecture 400 for implementing a continuous authentication procedure is shown. The processor 220 supports a system-wide TEE security technology implemented in an SoC. Example implementations of the TEE include, but are not limited to, Open Source TEE (OP-TEE) and QUALCOMM® Secure Extension Environment (QSEE). ARM®TrustZone® is a TEE security specification that, when incorporated into an ARM® enabled SoC, partitions hardware and software resources of the SoC. Other examples of TEE security specifications include Intel® TXT and AMD® Secure Execution Environment. The processor 220 (e.g., an application processor) supports two virtual processors (e.g., a first virtual processor and a second virtual processor). The first virtual processor may run a non-secure world software stack in a non-secure world 410. The non-secure world 410 may also be referred to as a normal world or as a Rich Execution Environment (REE). The second virtual processor may run a secure world software stack in a secure world 420. The two virtual processors are each associated with independent memory address spaces in the memory 230, namely a non-secure world address space 234 and a secure world address space 236. Further, the two virtual processors have different memory access privileges. Specifically, code (e.g., computer instructions, programs, software, firmware, etc.) running in the non-secure world 410 cannot access the secure world address space 236, however, code running in the secure world 420 can be enabled to access the non-secure world address space 234. The processor 220 can execute in one world at a time and switches between the non-secure world 410 and the secure world 420 in a time-slicing manner. The ARM®TrustZone® Monitor Software 460 coordinates switching instructions and hardware interrupts supported by a secure channel hardware abstraction layer (HAL) 462 and an ARM®TrustZone® Board Support Package (BSP) 464. The secure channel HAL 462 and the ARM®TrustZone® BSP 464 enable interactions between the ARM®TrustZone® Monitor Software 460, the GPOS 445, and the mobile device hardware, for example, to enable world switching, hardware interrupts, hardware partitioning, etc. as required to implement the TEE security technology. A special processor bit, known in the art as an “NS” bit, indicates in which world the processor 220 is currently executing, and the “NS” bit may be sent over a memory bus, an input/output bus for use by the memory, peripheral devices (e.g., the touch screen 120, the display panel 245), etc. As a result, access from each of the two worlds to the memory and to the peripheral devices can be controlled by the processor 220.

The non-secure world software stack includes a general purpose operating system (GPOS) 445. Examples of the GPOS 445 include, but are not limited to iOS®, Android®, Windows®, Blackberry®, Chrome®, Linux®, Symbian®, Palm®, etc. The non-secure world software stack may further include software applications 430, a GPOS Application Program Interface (GPOS API) 440, a display driver 443, and a secure channel driver 466. The software applications 430 that run on top of the GPOS 445 may be, for example, applications offered by a third party developer and downloadable by a user through the Internet, for example through GOOGLE PLAY® or the APPLE APP STORE®. The software applications 430 may include, for example, a bank application, a payment application, a point-of-sale application, a weather application, a calendar application, etc. The software applications 430 may include functionalities and interfaces that help perform standard tasks that require low levels of security. For example, a payment application may include programming instructions that allow a user of the payment provider entity to perform standard management tasks with an account, such as retrieving a purchase history. The display driver 443 may include software instructions for execution by the display driver interface 240 in order to control operations of the display panel 245. The secure channel driver 466 may execute instructions to support secure communications as needed, for example, by the software applications 430 and/or other software and/or firmware executed by the processor 220.

The secure world software stack may include secure applets 435, a static authentication service 447, and a baseline template generation service 448. The secure applets 435 (e.g., Applet A, Applet B, Applet C, etc.) are counterparts to the software applications 430 and control secure tasks associated with the software applications 430 (e.g., credential entry, identification entry, secure user interface, key access, encryption/decryption services, etc.). The secure applets 435 may be downloadable concurrently with and as a portion of the software applications 430.

The static authentication service 447 includes instructions executed by the static authentication module 227. For example, the static authentication service 447 may include instructions to prompt the user for entry of static authentication information using the display panel 245, the touch screen 120, and/or other mobile device sensors or I/O devices (e.g., camera, fingerprint scanner, retinal scanner, microphone, keyboard, etc.). In response to one or more conditions, the static authentication module 227 may instruct the processor 220 to place the mobile device 110 into a locked mode. The one or more conditions may include, for example, but are not limited to, a user requested device lock, expiration of a time out period from a last time user input to the mobile device 110 and/or from a prior static authentication, powering on the mobile device, a lock request from the CA module 225, etc. When the mobile device 110 is in the locked mode, the processor 220 may prevent the user from using all or substantially all of device functionality without entering the static authentication information to unlock the device. For example, access to wireless communications, stored data, device applications, etc. may be limited or unavailable to the user. The static authentication information may include, for example, a password, a PIN, a fingerprint, a retinal scan, a voice command, etc. The static authentication service 447 may further include instructions to evaluate the static authentication information to confirm user identity and user authorization for access to the mobile device 110.

The CA service 470 includes instructions executed by the CA module 225. The CA module 225 may execute the CA service 470 continuously for a duration of a continuous authentication session (CA session) as a background, or daemon, process without interruption of the execution of the software applications 430. The CA session may commence automatically in response to the entry of static authentication information that authenticates the user as the authorized user. The automatic commencement of the CA session in response to the static authentication may be an operational setting on the mobile device that the user may enable or disable according to user preference. Alternatively, the CA session may commence in response to a user request and/or confirmation. The CA session may continue as long as the CA module 225 determines that the mobile device user is the authorized user, as described in more detail below. If the CA module 225 determines that the mobile device user is the unauthorized user, the CA module 225 may discontinue the CA session. In an embodiment, the CA module 225 may determine the mobile device user to be the authorized user but may discontinue the CA session based on a discontinuation request from the authorized user. Additionally or alternatively, discontinuation of the CA session may occur based on a user determined mobile device setting to discontinue the CA session, for example, after a particular elapsed time during execution of a particular software application, after a particular elapsed time during overall usage of the mobile device, in response to resetting the static authentication information, etc.

The CA service 470 includes a collection service 480 and an analysis service 490. In an embodiment, the CA module 225 may be un-partitioned and may execute the CA service 470 entirely within the secure world 420, i.e., the collection service 480 and the analysis service 490 execute in the secure world 420. In an alternative embodiment, the CA module 225 may be partitioned between the non-secure world 410 and the secure world 420, i.e., the collection service 480 executes in the non-secure world 410 and the analysis service 490 executes in the secure world 420. The particular implementation of the CA module 225 depends upon TEE security specification configuration as determined by a manufacturer or vendor of the SoC. For example, the TEE security specification configuration may support multiple threading. In this case, the CA module 225 may be un-partitioned so that the collection service 480 and the analysis service 490 may both execute within the secure world 420. Alternatively, the TEE security specification configuration may support synchronous block calling. In this case, the module 225 may be partitioned so that the collection service 480 may execute within the non-secure world 410 and the analysis service 490 may execute within the secure world 420, as shown, for example, in FIG. 4. As discussed in more detail below, the collection service 480 includes instructions for the CA module 225 to collect the behavioral information and pass the behavioral information to the analysis service 490. The analysis service 490 includes instructions for the CA module 225 to generate and analyze an authentication template based on the behavioral information. The authentication template and associated analysis is protected in the secure world 420 and less vulnerable to attack or misuse by an illegal or unauthorized user of the mobile device 110.

The collection service 480 includes instructions that enable the CA module 225 to collect behavioral information from the primary input device of the mobile device 110. For example, the behavioral information may be the touch information generated during user interactions with the touch screen 120 as determined by the touch processor module 218 and described above with regard to FIGS. 2, 3A, and 3B. As other examples, not limiting of the disclosure, the behavioral information may be sound information, (e.g., information corresponding to a user's voice) generated during user interactions with a microphone or other audio device, keystroke information generated during user interactions with a keyboard, mouse click and/or mouse movement information generated during user interactions with a mouse, facial information generated during user interaction with a video input, etc. depending on the type of primary input device. The CA service 470 executing continuously during the CA session as a background process enables the collection service 480 to collect the behavioral information any time there is a user interaction with the primary input device during the CA session. In various implementations, the collection service 480 may collect the behavioral information for every touch event during the CA session or for touch events at certain intervals (e.g., equal intervals, varying intervals, randomized intervals, pre-determined intervals, dynamically adjusted intervals, etc. where the intervals are a time, such as a number or seconds or minutes, or a number of touch events, such as every other event, every fifth event, etc.) during the CA session.

The collection service 480 may obtain behavioral and application identification information according to various implementations. For example, a particular software application of the software applications 430 may call on the GPOS API 440 or the GPOS API 440 in combination with a development kit to obtain the behavioral information. In an implementation, the GPOS API 440 obtains the touch information from the touch screen controller module 210. The particular software application may then pass the behavioral information along with application identification information to the collection service 480 via an inter-process communication mechanism (i.e., a mechanism for sharing information between software and/or firmware processes using communication protocols as determined based on the processes). As another example, a kernel of the GPOS 445 may expose a device interface for the primary input device (e.g., the touch screen 120 and/or the touch screen controller module 210) as a device interface file in the memory 230. The device interface file may include the information determined by the touch screen controller module 210. The collection service 480 may monitor (i.e., open and read) the device interface file to obtain the touch information. The particular software application may own a foreground user interface and provide a process identification (PID) and/or an application identification (AID) to the collection service 480. In this case, the touch information corresponds to the software application that owns the foreground user interface as indicated by the AID. A monitoring service running in conjunction with and in the background of the collection service may combine the touch information with the AID. Alternatively, the collection service 480 may obtain the PID and/or the AID from an applications management service of the GPOS 445. The applications management service monitors the user interface and determines an AID and/or PID for the particular software application running in the foreground. For any of the above examples, implementation details may depend on the particular GPOS 445.

The collection service 480 further includes instructions that enable the CA module 225 to pass the behavioral information, e.g., a set of collected touch information, or pass the behavioral information and corresponding application identification information to the analysis service 490. For example, a first set of collected touch information may correspond to touch events occurring during execution of a first software application (e.g., a photo gallery application) in the foreground and a second set of collected touch information may correspond to touch events occurring during execution of a second software application (e.g., a texting application) in the foreground. The collection service 480 executing in the non-secure world 410 may call on world switching instructions to pass the behavioral information and application identification information to the analysis service 490 executing in the secure world 420. Examples of the world switching instructions include secure monitor code (SMC) for the ARM®TrustZone® security specification and safer mode extensions (SMX) for the Intel®TXT® security specification. Execution of the world switching instructions invokes monitor software (e.g., the ARM®TrustZone® Monitor Software 460) to switch from the non-secure virtual processor to the secure virtual processor and thereby provide the analysis service 490 with access to the behavioral information and application identification information. In various implementations, the collection service 480 may pass collected information to the analysis service 490 during the CA session for every touch event during the CA session, for touch events at certain intervals (e.g., equal intervals, varying intervals, randomized intervals, pre-determined intervals, dynamically adjusted intervals, etc. where the intervals are a time, such as a number or seconds or minutes, or a number of touch events, such as every other event, every fifth event, etc.), etc.

The analysis service 490 includes instructions that enable the CA module 225 to analyze the collected behavioral information and includes a classifier service 492, a feature extraction service 494, and an evaluator service 496. The CA service 470 executing continuously as a background process enables the analysis service 490 to analyze the collected behavioral information any time such information is collected during the CA session. In various implementations, the analysis service 490 may analyze the behavioral information for every touch event during the CA session or for touch events at certain intervals (e.g., equal intervals, varying intervals, randomized intervals, pre-determined intervals, dynamically adjusted intervals, etc. where the intervals are a time, such as a number or seconds or minutes, or a number of touch events, such as every other event, every fifth event, etc.) during the CA session.

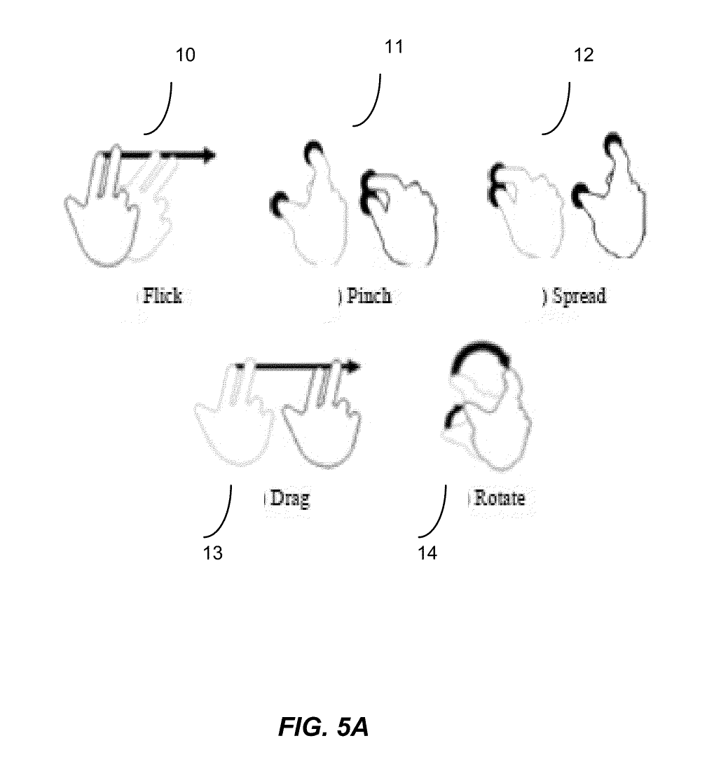

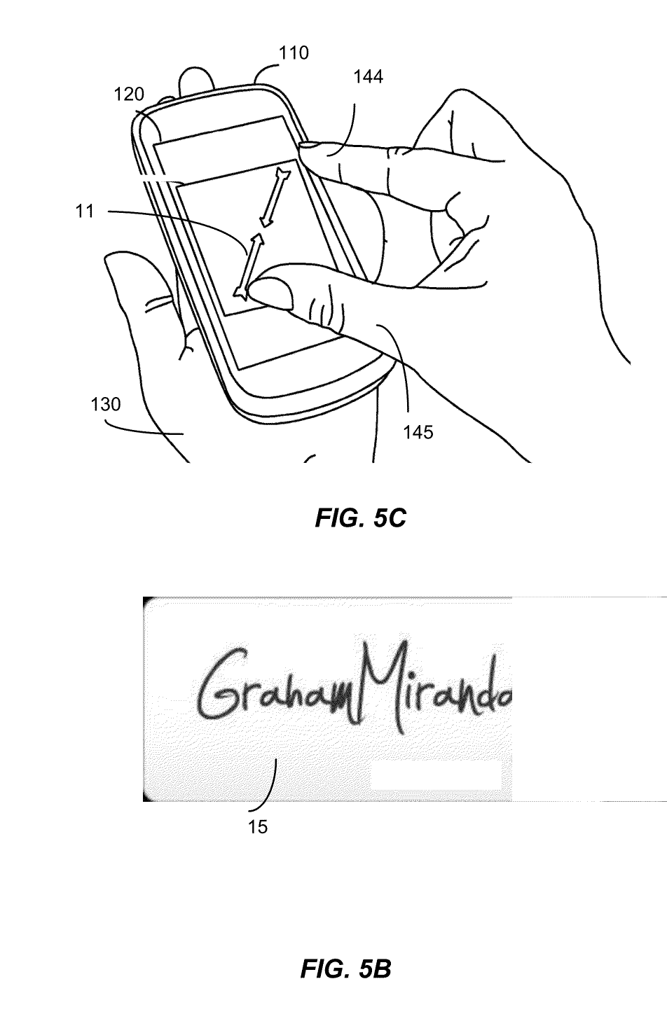

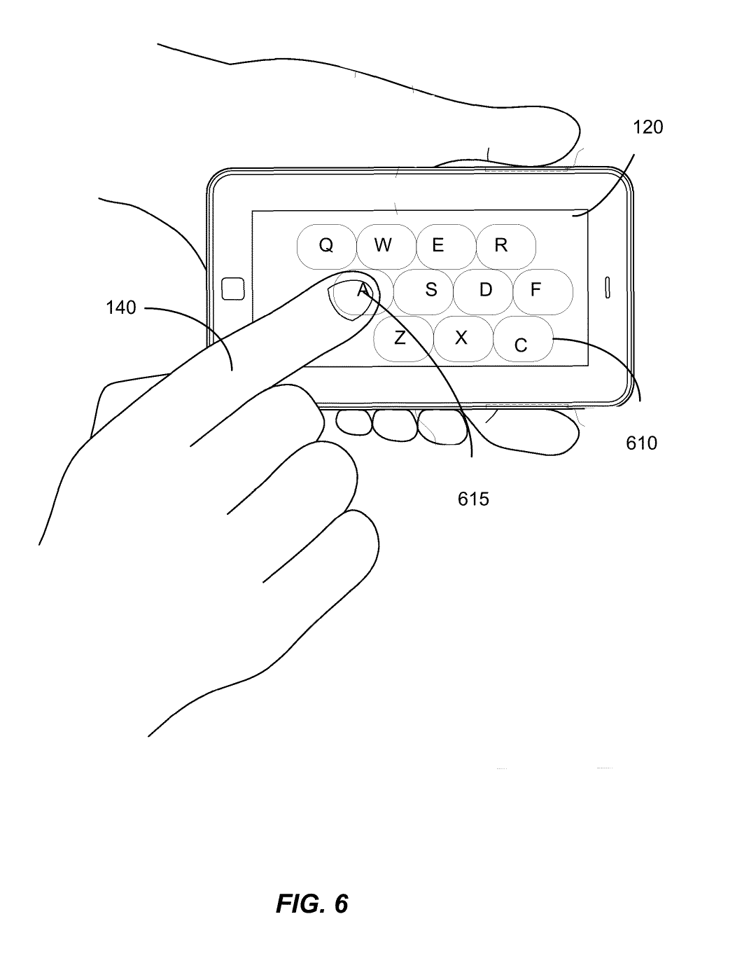

The classifier service 492 includes instructions that enable the CA module 225 to classify the behavioral information based on a classification algorithm (e.g., a machine learning algorithm such as a decision tree, a random forest algorithm, a Bayes Net classifier, etc.). For example, the CA module 225 may classify the touch information as a gesture, a signature, a hand-hold, or a keystroke. Referring to FIGS. 5A, 5B, and 6, illustrations of examples of classified touch information are shown. As shown, for example in FIG. 5A, the gesture may include but is not limited to, a flick gesture 10, a pinch gesture 11, a spread gesture 12, a drag gesture 13, and a rotate gesture 14. The gesture may include one or more strokes. As used herein, the term gesture refers to a brief interaction between the touch input element 140 and the touch screen 120. Based on classifier training associated with the particular classification algorithm, the classifier service 492 may distinguish between, for example, the flick gesture 10 and the drag gesture 13. For example, referring to FIG. 5B, the pinch gesture 11 may be performed on the touch screen 120 by two fingers 144, 145 of the user. As used herein, the term signature refers to a specific set of interactions between the touch input element 140 and the touch screen 120. For example, as shown further in FIG. 5B, the signature 15 may include an input of a user's name and may include a series of strokes. As used herein, the term hand-hold indicates one or more hands of the user in which the mobile device 110 is held. As used herein, the term keystroke indicates a brief interaction between the user and a key on a keyboard. For example, as shown in FIG. 6, the touch input element 140 may contact the touch screen 120 at a particular touch screen location corresponding to a key 615 (e.g., the “A” key in FIG. 5C) on a displayed touchscreen keyboard 610. The keystroke may correspond to a tap of the touch input element 140 on the key 615.

The feature extraction service 494 includes instructions that enable the CA module 225 to extract features associated with the classified behavioral information. For example, for hand-hold, extracted features may include right, left, or bimanual. For gestures, extracted features may include but are not limited to length, area, duration, direction, velocity magnitude, velocity direction, inter-gesture time (i.e., time between gestures), curvature, pressure, start time, stop time, start position, stop position, etc. For signature, extracted features may include but are not limited to the extracted features of the gestures along with number of strokes, order of strokes, inter-stroke distance (i.e., a distance between strokes), inter-stroke latency (i.e., an elapsed time between strokes), etc. For keystroke, extracted features may include but are not limited to pressure, area, latency, duration, typing speed, etc. The feature extraction service 494 may include instructions for the CA module 225 to determine average values for multiple sets of extracted features corresponding to touch events with a same classification For example, the feature extraction service 494 may include instructions for the CA module 225 to determine an average length of the pinch gesture for the multiple sets of touch events classified as the pinch gesture 11. The feature extraction service 494 may include instructions for the CA module 225 to store the extracted feature information in an authentication template. The authentication template is a data representation of the extracted features of the classified touch information. Further, the authentication template may indicate the application identification information associated with sets of extracted features. In other words, sets of extracted features may be grouped, categorized, or otherwise sorted according to respective software applications 430. The CA module 225 may store the authentication template in the secure world address space 236 of the memory 230. Therefore, the information in the authentication template is not accessible to the GPOS 445, the software applications 430, or to any software, firmware, or hardware operating in the non-secure world.

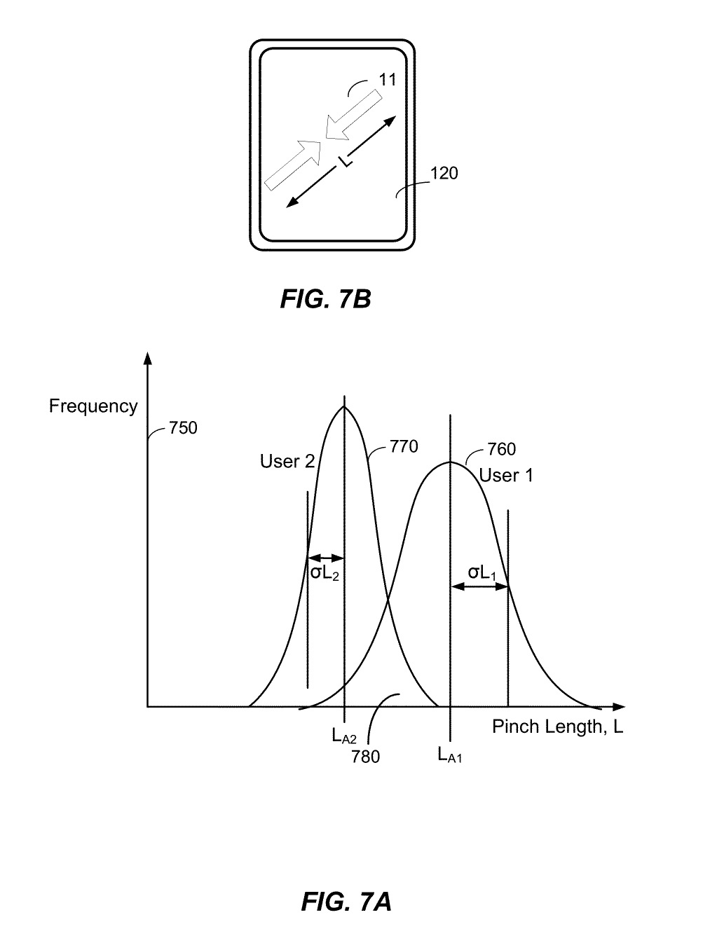

A statistical distribution of an extracted feature for one mobile device user may be distinguishable from the statistical distribution of the same extracted feature for another mobile device user. For example, referring to FIG. 7, illustrations of statistical distributions of an extracted feature for different users are shown. In this example, a pinch length L of the pinch gesture 11 may correspond to a first statistical distribution 760 associated with User 1 on a graph 750 of frequency versus the pinch length. The pinch gesture 11 may repeated a number of times by the first user (e.g., User 1) during operation of the touch screen 120. An average pinch length, L_{A1}, and a standard deviation, σ_{L1}, may be determined for the first statistical distribution 760. L_{A1} and σ_{L1} may be the extracted features determined by the feature extraction service 494 and one or more of these may be stored in the authentication template. The extracted features may distinguish User 1 from another user, User 2, and may identify either user for as the authorized user. For example, a second statistical distribution 770 for the pinch length may be associated with a pinch length exhibited by User 2. The first statistical distribution 760 and the second statistical distribution 770 may correspond to different average pinch length values, L_{A1} and L_{A2}, respectively and different standard deviations, σ_{L1} and σ_{L2}, respectively. However, there may be some overlap 780 in the statistical distributions of different users. The extracted features of touch information indicate a probability of user identity (e.g., indicate the probability that the user is User 1 or User 2) but do not unambiguously identify the user. Therefore, a user identification accuracy based on extracted features may improve as a number of samples of any single extracted feature increases with ongoing behavioral information collection. For example, the number of samples of extracted features from touch information may be on the order of hundreds or thousands. Further, the distinctions between users may further improve using multiple extracted features collected for multiple software applications. The statistical indicators (e.g., mean, standard deviation, etc.) used to characterize a distribution, and thereby distinguish between users, may be updated, refined, and improved continuously as the number of samples of the touch information increases.

The evaluator service 496 includes instructions that enable the CA module 225 to determine an authentication template vector. The CA module 225 may determine the authentication template vector based at least in part on the authentication template. For example, the CA module 225 may include in the authentication template vector one or more of the extracted features in the authentication template. In an implementation, the evaluator service 496 may include instructions for the CA module 225 to exclude from the authentication template vector one or more of the extracted features in the authentication template based on a previously stored baseline template for the user. For example, if the previously stored baseline template excludes extracted features for keystroke then the authentication template vector may exclude extracted features for keystroke even if the extracted features for keystroke are included in the authentication template. Generation of the previously stored baseline template along with reasons for excluding extracted features from the previously stored baseline template are discussed in more detail below with regard to the baseline template generation service 448. The baseline template generation service 448 may determine a baseline template vector based on the baseline template.

The evaluator service 496 further includes instruction that enable the CA module 225 to determine a score indicative of an inter-vector distance between the authentication template vector and the baseline template vector. The inter-vector distance between the authentication template vector and the baseline template vector is a measure of the degree to which the authentication template matches the previously stored baseline template. The inter-vector distance may be, for example, but not limited to, a Euclidean distance, a Manhattan distance, a Mahalonobis generalized distance, a Hamming distance, a Normalized Baysian classifier, Time Classification, etc. The extracted features of the classified touch information included in the authentication template and the baseline template are derived from independent touch behaviors. For example, hand-hold behavior of a user is independent of gesture behavior and/or keystroke behavior meaning that correlations between these behaviors can be assumed not to exist. Therefore, the score determined based on the inter-vector distance between the authentication template vector and the baseline template vector is a single score indicative of a comparison of multiple, uncorrelated touch behaviors. For example, instead of comparing a single behavior (e.g., compare previously stored baseline hand-hold information to real-time hand-hold information, compare previously stored baseline gesture information to real-time gesture information, compare previously stored baseline keystroke information to real-time keystroke information, etc.) the score summarizes an entire behavior profile associated with uncorrelated behaviors of the authorized user. This may improve identification accuracy as compared to identification based on one type of behavior.

Referring again to the evaluator service 496, this service includes instructions that enable the CA module 225 to generate a confidence level value, C, based on the score. The confidence level value is an indication of a confidence that the user is the authorized user and that the user has not changed since the commencement of the CA session. At the start of the CA session, the CA module 225 may initialize the confidence level value to indicate a high level of confidence that the user is the authorized user, i.e., there is no indication that the user has changed to the unauthorized user when the CA session starts. For example, the CA session may commence in response to entry of static authentication information indicating that the authorized user is operating the mobile device 110. The CA module 225 may compare the score based on the inter-vector distance between the authentication template vector the baseline template vector to a score threshold value, T. If the score exceeds the score threshold value then the probability that the user has changed increases. Conversely, if the score is less than the score threshold value then the probability that the user has changed decreases. In response to comparing the score to the score threshold value, the CA module 225 may generate the confidence level value according to a penalty and reward function. If the score is greater than or equal to the score threshold value, then the CA module 225 may update a previously determined confidence level by increasing the previously determined confidence level by a penalty amount. Conversely, if the score is less than the score threshold value, then the CA module 225 may update the previously determined confidence level by decreasing the previously determined confidence level value by a reward amount.

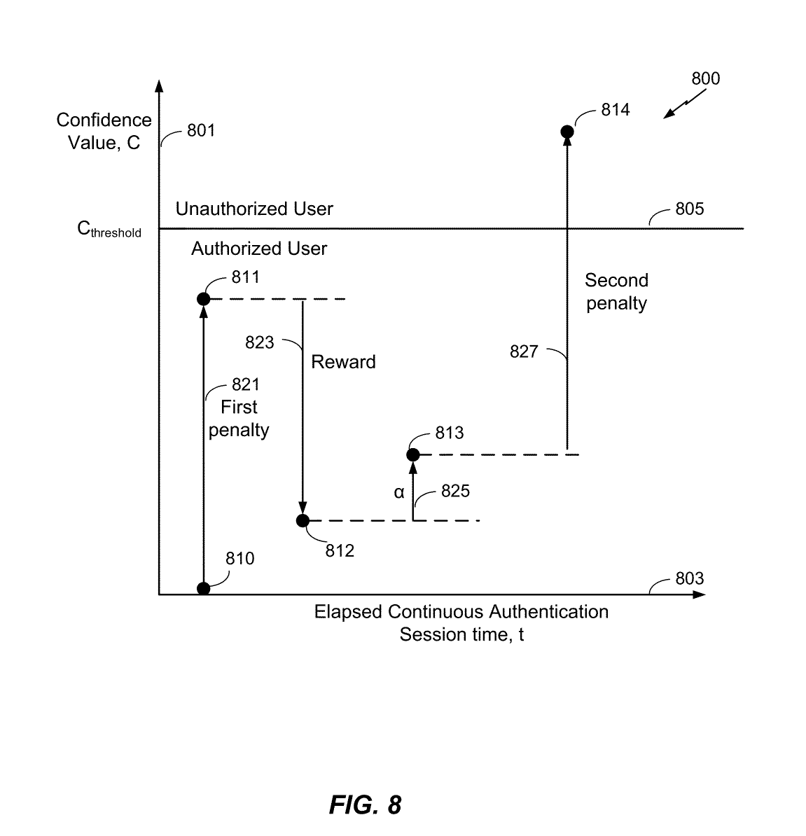

Referring to FIG. 8, a graph of the generated confidence value versus elapsed CA session time according to the penalty and reward function is shown. The graph 800 shown in FIG. 8 is an example only and not limiting of the disclosure. The graph 800 shows the confidence value C on the vertical axis 801 as a function of elapsed CA session time, t, on the horizontal axis 803. A point 810 is a value of C at some time, t. For example, the CA session may commence in response to the entry of static authentication information that authenticates the user as the authorized user and, in this case, the mobile device user at the beginning of the CA session may reasonably be assumed to be the authorized user. Thus, at a commencement of the CA session, the evaluator service may initialize the value of C to a value associated with the authorized user (e.g., a value less than and not equal to a confidence level threshold 805 in the example shown in FIG. 8). In an implementation, this initial value may be zero (i.e., C=0 at t=0). If the score is greater than the score threshold (i.e., the inter-vector distance between the authentication template vector and the baseline template vector is relatively large), then the CA module 225 may change the value of C by a penalty amount to indicate a decrease in confidence that the user is the authorized user (i.e., increased indication that the user has changed to the unauthorized user). The penalty amount changes the value of C in order to decrease a difference between the confidence level value and the confidence level threshold 805. In the example of FIG. 8, the CA module 225 changes the value of C at the point 810 by a first penalty amount 821 to reach the value of C at the point 811. The first penalty amount 821 may be equal to (d₁-T) where d₁ is the inter-vector distance between a first authentication template vector and the baseline template vector and T is the score threshold value. In other examples, the first penalty amount may be another function of the inter-vector distance, d₁, may be equal to one, or may be equal to another fixed numerical value.

If the score is less than the score threshold (i.e., the inter-vector distance, d, between the authentication template vector and the baseline template vector is relatively small), then the CA module 225 may decrease the value of C by a reward amount, R. This indicates an increase in confidence that the user is the authorized user (i.e., decreased indication that the user has changed to the unauthorized user). The reward amount changes the value of C in order to increase a difference between the confidence level value and the confidence level threshold. In the example of FIG. 8, the CA module 225 changes the value of C at the point 811 by a reward amount 823 to reach the value of C at the point 812. The reward amount 823 may be an empirically determined fixed value. In an example, the reward amount 823 may be equal to one or may be equal to another fixed numerical value.

With each application of the penalty or the reward, the evaluator service 496 may determine that the user of the mobile device is the authorized user of the mobile device based on the confidence level value generated by the penalty and reward function. Each updated confidence level value is generated by increasing or decreasing a previously determined confidence level value. The previously determined confidence level value may correspond to the initialized value at the commencement of the CA session. The CA session may continue as long as the CA module 225 determines that the mobile device user is the authorized user, i.e., as long as the generated confidence level value is below the confidence level threshold 805. However, if the generated confidence level value is greater than or equal to the confidence level threshold 805, then the CA module 225 determines that the mobile device user is the unauthorized user. In this case, the CA module 225 may discontinue the CA session. Conversely, if the generated confidence level value is less than the confidence level threshold 805, then the CA module 225 determines that the mobile device user is the authorized user. In this case, the CA module 225 may continue the CA session. In an alternative implementation of the penalty and reward function, if the generated confidence level value is less than the confidence level threshold, then the CA module determines that the mobile device user is the unauthorized user and if the generated confidence level value is greater than or equal to the confidence level threshold then the CA module determines that the mobile device user is authorized user.

Over a course of the CA session, the confidence score value may improve (i.e., the difference between the confidence score value and the confidence score value threshold may increase) in response to continued touch screen input by the authorized user and repeated applications of the reward. Furthermore, the penalty and reward function accounts for spurious legal user behavior because a one-time application of the penalty or the token penalty does not necessarily indicate the unauthorized user. Identification of the mobile device user as the authorized or the unauthorized user is based on a net effect of multiple penalties and rewards during the CA session. In contrast, if the identification of the authorized user was only based on the value of the score being above or below the score threshold as in the simple score/threshold model, then spurious authorized user behavior may result in a false identification of the unauthorized user and unnecessary interruption of device usage for the authorized user. Furthermore, the generated confidence level value at each application of the penalty and reward function is based on the most recent previously determined confidence level value (i.e., a current confidence level value is changed by the penalty or the reward). Therefore, the penalty and reward function also takes into account a current state of the mobile device.

At any time during the CA session, the difference between the value of C in and the confidence level threshold determines a number of penalties needed in order for the value of C to cross the confidence value threshold. This number of penalties corresponds to a period of time during which the unauthorized user may use the mobile device prior to detection. An acceptable duration of this time period prior to detection may depend on particular security requirements for the mobile device (i.e., higher security may correspond to a shorter time period than lower security). Therefore, the evaluator service 496 may restrict the value of C to limit the possible difference between the value of C and the confidence level threshold. In the example of FIG. 8, the evaluator service 496 may limit C to C≧0 by including a limiting function, for example, a maximum function so that C=max(C-R, 0) when the CA module 225 applies the reward, R. In other words, if subtracting the reward amount R from a current value of C would result in a negative generated value of C, then the CA module 225 sets the generated value of C at zero. This may reduce the time prior to detection of the unauthorized user.

If the extracted features of the authentication template vector do not appear in the baseline template vector, then the CA module 225 may change the previously determined value of C by a token penalty amount, α. The value of a is a small value (e.g., 0.5%-10%) relative to the current value of C, the confidence level threshold, the reward, and the penalty. Thus the unauthorized user cannot entirely avoid the penalty with entries outside of the baseline template in an effort to circumvent the security provided by user authentication. In the example of FIG. 8, at a point 813, the CA module 225 increases C from the value at the point 812 by the token penalty amount 825.

The possible values of C for an example of the penalty and reward function may be summarized as shown below as Equation 1:

$$C := \{ \begin{matrix}max ( C - R , 0 ) , d \leq T & ( Reward = R ) \\ C + ( d - T ) , d > T & ( Penalty = ( d - T ) ) \\ C + α , & ( extracted feature not in template ) \\ 0 , & ( initial value )\end{matrix} . \qquad ( 1 )$$

Equation 1 is not limiting of the disclosure as other initial values, reward values, penalty values, and limiting functions may be used.

If the value of C crosses the confidence level threshold 805, then the confidence that the user is the authorized user is sufficiently low to warrant restricting access to the mobile device functions. For example, the CA module 225 changes the value of C at point 813 by a second penalty amount 827 to reach the value at the point 814. The second penalty amount 827 is equal to (d₂-T) where d₂ is the inter-vector distance between a second authentication template vector and the baseline template vector. In other examples, the second penalty amount may be another function of the inter-vector distance, d₂, may be equal to one, or may be equal to another fixed numerical value. The second penalty amount 827 is shown as greater than the first penalty amount 821 in FIG. 8 as an example only. The second penalty amount and/or any subsequent penalty amounts may be less than, equal to, or greater than the first penalty and/or any prior penalty amounts. In this example, the second penalty amount 827 raises the value of C at a point 814 above C_{threshold}. For a confidence level value above C_{threshold}, the evaluator service 496 may include instructions for the CA module 225 to discontinue the CA session and generate an unauthorized user flag. In response to the unauthorized user flag, the processor 220 may restrict access to functions of the mobile device and/or data stored on the mobile device. Additionally, the static authentication module 227 may generate a prompt for static authentication information. The mobile device access may remain restricted until the user enters the static authentication information.

The penalty, R, α, T, and/or C_{threshold} values may be empirically determined A device manufacturer, a software developer, a third party, etc. may gather data for multiple users, software applications, and/or devices and determine predictive models of behavioral information that may be generally applicable to multiple devices, applications, and/or users. One or more of the values of the penalty, R, α, T, or C_{threshold} may be pre-determined as a fixed value for use by the CA service 470 based on such predictive models. Thus, one or more of these values may be the same for multiple users, multiple software applications, and/or multiple devices. Alternatively or additionally, one or more of these quantities may be empirically determined in real-time based on behavioral information collected during usage of a particular mobile device and/or may be user entered settings for the continuous authentication procedure implemented in the particular mobile device. In this way, one or more of these values may be specific to a particular user, a particular software application, and/or a particular mobile device. As an example, the value of C_{threshold} may be set at a highest C value resulting from the application of the penalty and reward function over some period of time for a particular user. In this way, a range of behavioral information variation may be accounted for to avoid subjecting the authorized user to restricted access during a period of inconsistent touch behavior. As a further example, the score threshold value, T, may be empirically determined based, for example on an estimation of two types of errors. First, the authorized user may provide a touch input that is far away from his own baseline template which may be considered False Non-Match. On the other hand, the unauthorized user might provide a touch input that is close to the authorized user's baseline template which may be considered a False Match. The probability of occurrence of these errors may be expressed in the False Non-Match Rate (FNMR) and the False Match Rate (FMR). These two error rates depend on the chosen score threshold value. In general, if the score threshold value is higher (i.e., corresponding to a larger value of the inter-vector distance and a large variation in user behavior) then the FMR will increase while the FNMR will decrease. If the score threshold value is lower (i.e., corresponding to a smaller value of the inter-vector distance and a small variation in user behavior), then the FMR will decrease and the FNMR will increase. In an implementation, the score threshold value may be set such that the FNMR equals the FMR. User specific, application specific, and/or mobile device specific penalty, R, α, T, and/or C_{threshold} values may account for behavioral variations by the authorized user and/or induced by the software applications and/or the mobile device and thereby optimize the performance of the CA procedures. The CA service 470 may adjust one or more of these values according to the software application based on the application identification information provided by the collection service 480.

The penalty, R, α, T, and/or C_{threshold} values may be dynamically adjusted based on one or more of security requirements, mobile device context, time of use, or any combination thereof. For a continuous authentication system, the performance of the system may be expressed in terms of how long it takes before the CA module 225 detects the unauthorized user. For example for the case of touch information, the system performance may be determined by the number of touch events corresponding to the unauthorized user that occur before the value of C exceeds C_{threshold}. The better a system performs, the lower this number of touch events will be as the lower number corresponds to a faster detection of the unauthorized user. This performance is also linked to the values of the penalty, α, R, T, and C_{threshold}. If values of R, T, and/or C_{threshold} are too high and/or if the values of the penalty and a are too low, then the unauthorized user may be able to use the mobile device for a longer period of time before detection than is desirable for system security (e.g., a period of time long enough to corrupt device functions, view and/or copy information stored on the mobile device, impersonate the user in utilizing software applications with stored passwords, etc.). Conversely, if the values of R, T, and/or C_{threshold} are too low and/or if the values of the penalty and a are too high, then the CA module 225 may erroneously flag the unauthorized user based on normal variations in touch information and use of the mobile device may be restricted more often than desirable by the user of the mobile device.

With regard to security, penalty, R, α, T, and/or C_{threshold} values that increase the length of time that the unauthorized user may use the mobile device without detection may be appropriate for lower security applications and penalty, R, α, T, and/or C_{threshold} values that decrease the length of time that the unauthorized user may use the mobile device without detection may be appropriate for higher security applications For the score threshold, it might be desirable to have a low FMR for higher security or a low FNMR for lower security. With regard to C_{threshold}, for higher security, this value may be set closer to the initial value of C in order to reduce the time to detect the illegal user and/or in order to restrict an amount of behavioral variation attributed to the authorized user. For similar reasons, the penalty value and/or the value of a may be set higher for higher security than for lower security and the R value may be set lower for higher security than for lower security. The security requirements may vary between software applications and/or based on mobile device location and/or time of use. For example, a banking application may require higher security than a photo gallery application due to the undesirability of an unauthorized user accessing sensitive financial information. The communications module 260 may provide mobile device location information to the CA module 225. The CA module 225 may dynamically adjust one or more of the penalty, R, α, T, and/or C_{threshold} values based on the location information in order to provide higher security when the mobile device is located in a public location (e.g., an airport, a shopping area, a train station, an outdoor venue, etc.) than when the mobile device is located in a private location (e.g., a home, an office, a car, etc.). Location information that indicates a new location of the mobile device may trigger higher security settings as well (e.g., a location in a city far from the residence or office of the authorized user). Additionally, the CA module 225 may dynamically adjust one or more of these values to provide lower security when the authorized user may be most likely to use the device in order to reduce erroneous detection of the unauthorized user and the resulting inconvenience for the authorized user. Similarly, the time of use (e.g., time of day, day of a week, etc.) may determine the security requirements based on historical usage of the mobile device by the authorized user. As an example, the historical usage may indicate that the authorized user rarely or never uses certain applications at night or on weekends. In such an example, if the application identification information and clocks and timing circuitry indicate unusual usage of the certain applications at night or on a weekend, the CA module 225 may dynamically adjust one or more of the penalty, R, α, T, and/or C_{threshold} values in order to provide higher security in response to the unusual or unexpected usage of the mobile device. Likewise, the CA module 225 may dynamically adjust one or more of these values to provide lower security in response to usual or expected time of use of the mobile device. The effects of location and time of use on these values may be adjustable settings by the authorized user.

The penalty, R, α, T, and/or C_{threshold} values may also be dynamically adjusted in real-time based on the statistical distributions of the extracted features. Generally, a low number of samples of the extracted features may correspond to a distribution with a wider associated variation than a statistical distribution for a larger number of samples. Therefore, as the CA session proceeds, the statistical distributions for the extracted features may narrow (i.e., the variation associated with the distribution decreases) and/or the distribution overlap 780 (e.g., as discussed with regard to FIG. 7) may decrease. Thus, as the CA session proceeds, the authorized user may be more accurately distinguished from the unauthorized user. The CA module 225 may adjust the penalty, R, α, T, and/or C_{threshold} values so as to account for the reduction in the statistical variation associated with the behavioral information of the authorized user.

In an implementation, the CA module 225 may evaluate C during operation of one or more software applications. If the CA module 225 detects the unauthorized user, the processor 220 may restrict access to the mobile device as a whole or to one or more of the software applications. The CA module 225 may evaluate C per software application based on the sets of touch information corresponding to particular application identification information. In this case, each application may correspond to an application specific authentication template vector. Thus, at any time during the operation of each software application, the CA module 225 may detect the unauthorized user of the particular software application. In response, the processor 220 may only restrict access to information and functions of the particular software application rather than the mobile device as a whole. In this case, the particular software application may request entry or re-entry of security information to restore unrestricted access to the particular software application.

Referring again to FIG. 4, the baseline template generation service 448 includes instructions executed by the baseline template generation module 223. The baseline template generation service 448 enables the baseline template generation module 223 to generate the previously stored baseline template during an enrollment session prior to the CA session. The baseline template generation service 448 may run, at least in part, as a background process in order to generate the baseline template in a manner transparent to the user. The enrollment session is a time period during which the generation module 223 may collect and analyze behavioral enrollment information, for example, the touch information, in order to generate the baseline template. The baseline template characterizes expected behavioral information for the authorized user. As discussed above with regard to FIG. 7, a number of samples of extracted features must be high to yield a statistical distribution sufficiently narrow (i.e., corresponding to a relatively low standard deviation) in order to distinguish between users. Therefore, a duration of an enrollment session (e.g., number of hours, days, etc.) may be empirically determined based on the number of samples of extracted features needed to provide the sufficiently narrow distribution. In an implementation, the enrollment session duration may be a predetermined value based on models for expected statistical distributions of behavioral data. For example, a device manufacturer may collect behavioral information from multiple people using a touch screen to determine the models for expected statistical distributions as a function of the enrollment session duration and/or a certain number of samples of behavioral information. The predetermined value of the enrollment session duration may be a default enrollment session duration that is optionally adjustable by the mobile device user. In an implementation, the enrollment session duration may be dynamically adjusted based on a statistical indicators determined in real-time for the extracted features. For example, the generation module 223 may monitor a variation or standard deviation of one or more extracted features. The enrollment session may end when the variation reaches a certain pre-determined and/or adjustable value. In an implementation, the enrollment session may end when the number of samples of a particular extracted feature reaches a pre-determined value. The generation module 223 may start the enrollment session automatically in response to initial entry of static authentication information that establishes the authorized user of the device, for example, during initial set-up procedures to establish the authorized user. Alternatively, the generation module 223 may start the enrollment session in response to a user request.

The generation module 223 may instruct the CA module 225 to collect behavioral enrollment information and application identification information as similarly described above with regard to the CA service 470. In an implementation, the CA module 225 may collect the behavioral enrollment information during normal use of the device by the user during the enrollment session. In an alternative implementation, the generation module 223 may request input of particular behavioral enrollment information by the user. For example, the generation service 448 may include instructions for the generation module 223 to prompt the user to enter a certain number of samples of particular behavioral enrollment information (e.g., a particular gesture, particular keystrokes and/or keystroke sequences, a particular number of signatures, etc.). The generation service 448 may further include instructions for the CA module 225 to classify the collected behavioral enrollment information and extract features as similarly described above with regard to the classifier service 492 and the feature extraction service 494. The CA module 225 may communicate the extracted features to the generation module 223.

The generation module 223 may receive the extracted features from the CA module 225 and store the extracted feature information as the baseline template. The baseline template is a data representation of the extracted features of the classified behavioral enrollment information. The generation module 223 may store the baseline template in the secure world address space 236 of the memory 230. Therefore, the information in the baseline template may not be accessible to the GPOS 445, the software applications 430, or to any software, firmware, or hardware operating in the non-secure world. The baseline template may indicate the application identification information associated with the extracted feature information. In an implementation, multiple baseline templates may be generated corresponding to multiple authorized users of the mobile device.

The baseline template may further include statistical indicators for the extracted features (e.g., a mean, a standard deviation, etc.). Based on these statistical indicators, one or more extracted features may be excluded from the baseline template. For example, if the variation associated with a particular extracted feature is high relative to other extracted features and/or if the particular extracted feature occurs infrequently during the enrollment session, the particular feature may be the excluded feature. The high variation and/or infrequency of occurrence may render the statistical distribution associated with the excluded feature for one user indistinguishable from the statistical distribution associated with another user for the same extracted feature. Such extracted features may be superfluous in the sense that these features may not contribute to identification of the user.

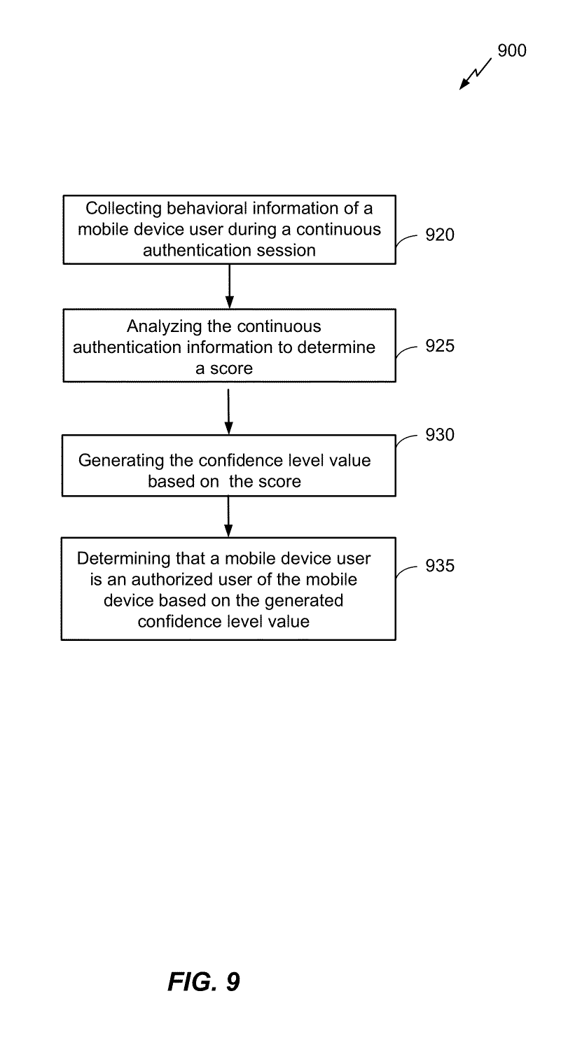

Referring to FIG. 9, a method 900 of implementing continuous authentication of a mobile device user is shown. The method 900 is, however, an example only and not limiting. The method 900 can be altered, e.g., by having stages added, removed, rearranged, combined, and/or performed concurrently.

At stage 920, the method 900 includes collecting behavioral information of a mobile device user during a continuous authentication session. For example, the CA module 225 may execute the collection service 480 in the non-secure world 410 or in the secure world 420 to collect the behavioral information. The behavioral information may include the touch information collected by the CA module 225 with the touch screen 120 being the primary input device. Alternatively or additionally, the behavioral information may include the voice information, the keystroke information, etc. as determined by the type of primary input device or primary input device combination. In an implementation, the stage 920 may include automatically commencing the CA session in response to receiving an indication of static authentication. For example, the CA module 225 may receive the indication of static authentication from the static authentication module 227. The automatic commencement of the CA session in response to the static authentication may be an operational setting on the mobile device that the user may enable or disable according to user preferences. Alternatively, the stage 920 may include receiving a user request and/or a user confirmation to commence the CA session. For example, the CA module 225 may receive the user request and/or confirmation. The CA module 225 may receive the user request and/or confirmation in response to a prompt for the user to request and/or confirm commencement. In an embodiment, the stage 920 may include initializing a confidence level value at the commencement of the CA session. As described above, the CA module 225 may execute the evaluator service 496 in the secure world 420 to initialize the confidence level value at a value not equal to the confidence level threshold, for example, at zero (i.e., C=0). The stage 920 may further include collecting application identification information during the CA session. In an implementation, the stage 920 includes passing the collected behavioral and application identification information by the CA module 225 between partitioned services, e.g., from the collection service 480 executing in the non-secure world 410, to the analysis service 490 executing in the secure world 420.

At stage 925, the method 900 includes analyzing the behavioral information to determine a score. For example, the CA module 225 may execute the analysis service 490 in the secure world 420 to analyze the behavioral information. Analyzing the behavioral information may include classifying the touch information, extracting features of the classified touch information, storing the extracted features in the authentication template, determining an authentication template vector, and determining the score based on the inter-vector distance between authentication template vector and a baseline template vector. For example, the CA module 225 may execute the classifier service 492 in the secure world 420 to classify the touch information. Further, the CA module 225 may execute the feature extraction service 494 in the secure world 420 to extract features from the classified touch information and may store the extracted features in the authentication template in the secure world address space 236. Analyzing the behavioral information may include analyzing the touch information corresponding to a particular software application 430. The CA module 225 may execute the evaluator service 496 in the secure world 420 to determine the authentication template vector and the score. The extracted features included in the authentication template vector may be based on the authentication template and on a previously stored baseline template. The score may be the inter-vector distance, as discussed above, between the authentication template vector and the baseline template vector. In an embodiment, the stage 935 may further include determining multiple scores based on multiple inter-vector distances between the authentication template vector and multiple baseline template vectors corresponding to the baseline templates generated and stored to authenticate members of a group of legal users.

At stage 930, the method 900 includes generating the confidence level value based on the score. For example, the CA module 225 may execute the evaluator service 496 in the secure world 420 to generate the confidence level value. Generating the confidence level may include comparing the score to a score threshold value, T and increasing or decreasing the previously determined confidence level, as determined by the comparison. For example, if the score is greater than or equal to the score threshold, then generating the confidence level value may include increasing a previously determined confidence level by a penalty or token penalty amount. If the score is less than the score threshold, then generating the confidence level value may include decreasing the previously determined confidence level value by a reward amount. Generating the confidence level value may further include setting the confidence level value at a fixed value. For example, the fixed value may be the maximum of the previously determined confidence level reduced by the reward amount and zero. The fixed value may be an initial value that indicates a high degree of confidence that the mobile device user is the authorized user. In an example, the initial value may be zero. Initializing the confidence level value to indicate the high degree of confidence that the mobile device user is the authorized user may occur in response to receiving an indication of static authentication information at the CA module 225 from the static authentication module 227. In an implementation, the stage 930 may include generating the confidence level value based on a smallest score of multiple scores determined based on multiple baseline template vectors. In this case, the confidence level value indicates the confidence that the current user of the mobile device is the member of the group of legal users corresponding to the multiple baseline template vectors.

At stage 935, the method 900 includes determining that a mobile device user is an authorized user of the mobile device based on the generated confidence level value. For example, the CA module 225 may execute the evaluator service 496 in the secure world 420 to determine that the mobile device user is the authorized user of the mobile device. Determining that the mobile device user is the authorized user may include comparing the generated confidence level value to a confidence level threshold, C_{threshold}. If the generated confidence level value is less than the confidence level threshold, then the CA module 225 may determine the mobile device user to be the authorized user. In this case, the method 900 may include continuing the CA session and collecting further behavioral information. The authorized user may continue to use the mobile device without interruption and the CA session may continue as long as the value of C stays below the confidence level threshold. In an embodiment, the CA module 225 may determine the mobile device user to be the authorized user but may discontinue the CA session based on the discontinuation request from the authorized user or the user determined mobile device setting to discontinue the CA session, as discussed above.

If the generated confidence level value is greater than or equal to the confidence level threshold, then the stage 935 may include determining that the mobile device user is an unauthorized user of the mobile device. In this case, the stage 935 may include generating an unauthorized user flag and/or discontinuing the CA session by the CA module 225. In response to generating the unauthorized user flag, the stage 935 may further include restricting access to the mobile device. For example, the processor 220 may receive the illegal user flag from the CA module 225 and may restrict access to one or more mobile device functions including all or a portion of the one or more software applications and/or access to all or a portion of the data stored on the mobile device. In this case, the stage 935 may further include generating the prompt for static authentication information by, for example, the static authentication module 227.

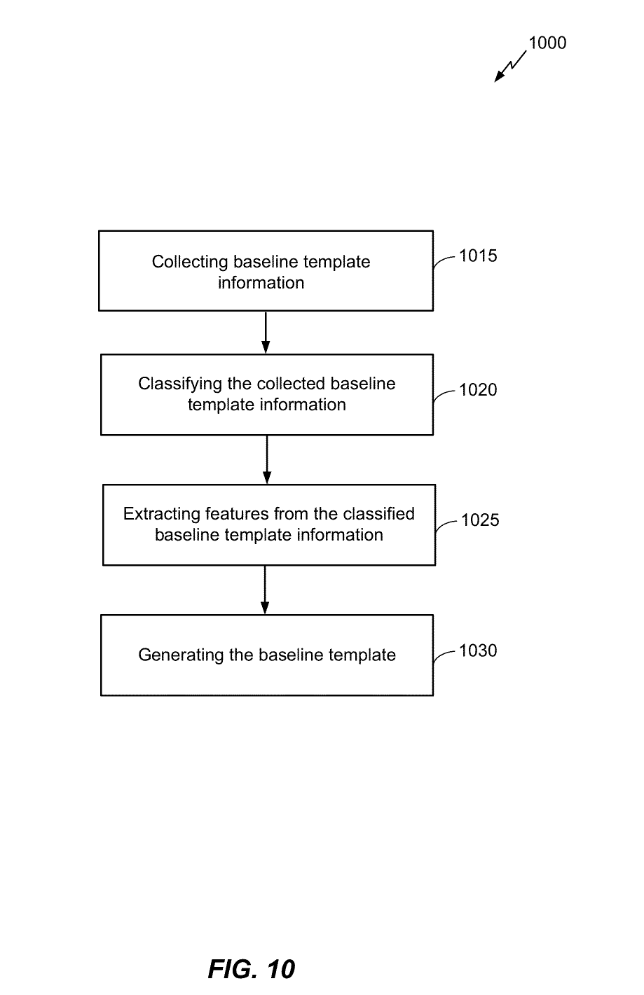

Referring to FIG. 10, a method 1000 for generating a baseline template is shown. The method 1000 is, however, an example only and not limiting. The method 1000 can be altered, e.g., by having stages added, removed, rearranged, combined, and/or performed concurrently.

At stage, 1015, the method 1000 includes collecting baseline template information. For example, the baseline template generation module 223 may execute code in the non-secure world 410 or the secure world 420 (e.g., the baseline template generation service 448 and/or the collection service 480) to collect the baseline template information. The baseline template information may include behavioral information, for example, the touch information, and the application identification information. In an implementation, collecting baseline template information may include requesting input of particular behavioral information by the user and prompting the user for the particular behavioral information. In an embodiment, collecting baseline template information may include collecting the touch information for one or more legal users.

At stage 1020, the method 1000 includes classifying the collected baseline template information. For example, the baseline template generation module 223 may execute code in the secure world 420 (e.g., the baseline template generation service 448 and/or the classifier service 492) to classify the touch information in a manner similar to that described at stage 925 of the method 900.

At stage 1025, the method 1000 includes extracting features from the classified baseline template information. For example, the baseline template generation module 223 may execute the baseline template generation service 448 and/or the feature extraction service 494 in the secure world 420 to extract features of the touch information in a manner similar to that described at stage 925 of the method 900.

At stage 1030, the method 1000 includes generating the baseline template. For example, the baseline template generation module 223 may execute the baseline template generation service 448 in the secure world 420 to generate the baseline template. The baseline template generation module 223 may generate one or more baseline templates. For example, in an embodiment, multiple baseline templates may be generated for multiple legal users of the mobile device. Generating the baseline template may include storing the baseline template information in the secure world address space 236 of the memory 230. The baseline template information may include the extracted features. In an implementation, the stage 1030 may include determining statistical indicators and/or application identification information associated with the extracted features. In a further implementation, the stage 1030 may include excluding one or more extracted features from the baseline template based on the determined statistical indicators. Determining the statistical indicators may include evaluating the statistical indicators to determine the enrollment session duration. For example, as discussed above, the enrollment session duration may be dynamically adjusted based on the statistical indicators associated with the extracted features determined in real-time as the baseline template generation proceeds.

Other Considerations

Other embodiments are within the scope of the invention. For example, due to the nature of software, functions described above can be implemented using software, hardware, firmware, hardwiring, or combinations of any of these. Features implementing functions may also be physically located at various locations, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media (e.g., a computer program product) might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

Information and signals may be represented using any of a variety of different technologies and techniques. For example, data, instructions, commands, information, signals, and symbols that may be referenced throughout the above description may be represented by voltages, currents, electromagnetic waves, magnetic fields or particles, optical fields or particles, or any combination thereof.

The methods, systems, and devices discussed above are examples. Various alternative configurations may omit, substitute, or add various procedures or components as appropriate. Configurations may be described as a process which is depicted as a flow diagram or block diagram. Although each may describe the operations as a sequential process, many of the operations can be performed in parallel or concurrently. In addition, the order of the operations may be rearranged. A process may have additional stages not included in the figure.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the disclosure. For example, the above elements may be components of a larger system, wherein other rules may take precedence over or otherwise modify the application of the invention. Also, a number of operations may be undertaken before, during, or after the above elements are considered. Also, technology evolves and, thus, many of the elements are examples and do not bound the scope of the disclosure or claims. Accordingly, the above description does not bound the scope of the claims. Further, more than one invention may be disclosed.

What is claimed is:

1. A method of implementing continuous authentication of a mobile device user in a mobile device, the method comprising:
collecting behavioral information of the mobile device user during a continuous authentication session;
analyzing the behavioral information to determine a score;
generating a confidence level value based on the score; and
determining that the mobile device user is an authorized user of the mobile device based on the generated confidence level value.

2. The method of claim 1 further comprising:
collecting the behavioral information in a non-secure world of a trusted execution environment (TEE);
passing the behavioral information from the non-secure world of the TEE to a secure world of the TEE; and
analyzing the behavioral information in the secure world of the TEE.

3. The method of claim 2 further comprising:
collecting application identification information for a particular application corresponding to the behavioral information; and
passing the application identification information for the particular application from the non-secure world of the TEE to the secure world of the TEE, wherein the analyzing the behavioral information further comprises analyzing the behavioral information corresponding to the particular application.

4. The method of claim 1 wherein the behavioral information comprises touch information.

5. The method of claim 1 wherein the generating the confidence level value based on the score comprises:
comparing the score to a score threshold value; and
generating the confidence level value by increasing or decreasing, as determined by the comparison, a previously determined confidence level.

6. The method of claim 1 wherein the analyzing the behavioral information to determine the score comprises:
classifying the behavioral information;
extracting features of the classified behavioral information;
storing the extracted features in an authentication template;
determining an authentication template vector based on the authentication template; and
determining the score wherein the score is an inter-vector distance between the authentication template vector and a baseline template vector, the baseline template vector being determined from a previously stored baseline template.

7. The method of claim 1 further comprising:
determining that the mobile device user is the authorized user of the mobile device based on the generated confidence level value being less than or equal to a confidence level threshold;
determining that the mobile device user is an unauthorized user of the mobile device based on the generated confidence level value being greater than the confidence level threshold; and
in response to determining that the mobile device user is the unauthorized user of the mobile device, discontinuing the continuous authentication session and restricting access to the mobile device.

8. The method of claim 1 further comprising initializing the confidence level value at a commencement of the continuous authentication session, wherein generating the confidence level value includes updating the confidence level value.

9. The method of claim 1 comprising:
receiving static authentication information; and
in response to receiving the static authentication information, automatically commencing the continuous authentication session.

10. A mobile device comprising:
a processor configured to:
collect behavioral information of a mobile device user during a continuous authentication session;
analyze the behavioral information to determine a score and to
generate a confidence level value based on the score; and
determine that the mobile device user is an authorized user of the mobile device based on the generated confidence level value.

11. The mobile device of claim 10, the processor further configured to:
collect the behavioral information in a non-secure world of a trusted execution environment (TEE);
collect application identification information for a particular application corresponding to the behavioral information;
pass the behavioral information and the application identification information for the particular application from the non-secure world of the TEE to a secure world of the TEE; and
analyze the behavioral information, corresponding to the application identification information for the particular application, in the secure world of the TEE.

12. The mobile device of claim 10 wherein the behavioral information comprises touch information.

13. The mobile device of claim 10 wherein the processor configured to analyze the behavioral information is further configured to :
classify the behavioral information;
extract features of the classified behavioral information;
store the extracted features in an authentication template;
determine an authentication template vector based on the authentication template;
determine the score wherein the score is an inter-vector distance between the authentication template vector and a baseline template vector, the baseline template vector being determined from a previously stored baseline template,
compare the score to a score threshold value; and
generate the confidence level value by increasing or decreasing, as determined by the comparison, a previously determined confidence level value.

14. The mobile device of claim 10 wherein the processor is further configured to:
determine that the mobile device user is the authorized user of the mobile device based on the generated confidence level value being less than or equal to a confidence level threshold;
determine that the mobile device user is an unauthorized user of the mobile device based on the generated confidence level value being greater than the confidence level threshold; and
in response to the determination that the mobile device user is the unauthorized user of the mobile device, discontinue the continuous authentication session and restrict access to the mobile device.

15. The mobile device of claim 10 wherein the processor is further configured to initialize the confidence level value at a commencement of the continuous authentication session and wherein the processor configured to analyze the behavioral information to generate the confidence level value is further configured to analyze the behavioral information to update the confidence level value.

16. The mobile device of claim 10 wherein the processor is further configured to:
receive static authentication information; and
automatically commence the continuous authentication session in response to receiving the static authentication information.

17. A non-transitory, computer-readable medium, having stored thereon computer-readable instructions for implementing continuous authentication of a mobile device user in a mobile device, comprising instructions configured to cause the mobile device to:
collect behavioral information of the mobile device user during a continuous authentication session;
analyze the behavioral information to determine a score and to generate a confidence level value based on the score; and
determine that the mobile device user is an authorized user of the mobile device based on the generated confidence level value.

18. The non-transitory, computer-readable medium of claim 17, further comprising instructions configured to cause the mobile device to:
collect the behavioral information in a non-secure world of a trusted execution environment (TEE);
collect application identification information for a particular application corresponding to the behavioral information;
pass the behavioral information and the application identification information for the particular application from the non-secure world of the TEE to a secure world of the TEE; and
analyze the behavioral information, corresponding to the application identification information for the particular application, in the secure world of the TEE.

19. The non-transitory, computer-readable medium of claim 17 wherein the behavioral information comprises touch information.

20. The non-transitory, computer-readable medium of claim 17, wherein the instructions configured to cause the mobile device to analyze the behavioral information further comprise instructions configured to cause the mobile device to:
classify the behavioral information;
extract features of the classified behavioral information;
store the extracted features in an authentication template;
determine an authentication template vector based on the authentication template;
determine the score wherein the score is an inter-vector distance between the authentication template vector and a baseline template vector, the baseline template vector being determined from a previously stored baseline template;
compare the score to a score threshold value; and
generate the confidence level value by increasing or decreasing, as determined by the comparison, a previously determined confidence level value.

21. The non-transitory, computer-readable medium of claim 17, further comprising instructions configured to cause the mobile device to:
determine that the mobile device user is the authorized user of the mobile device based on the generated confidence level value being less than or equal to a confidence level threshold;
determine that the mobile device user is an unauthorized user of the mobile device based on the generated confidence level value being greater than the confidence level threshold; and
in response to the determination that the mobile device user is the unauthorized user of the mobile device, discontinue the continuous authentication session and restrict access to the mobile device.

22. The non-transitory, computer-readable medium of claim 17, further comprising instructions configured to cause the mobile device to initialize the confidence level value at a commencement of the continuous authentication session and wherein the instructions to cause the mobile device to analyze the behavioral information to generate the confidence level value are further configured to cause the mobile device analyze the behavioral information to update the confidence level value.

23. The non-transitory, computer-readable medium of claim 17, further comprising instructions configured to cause the mobile device to:
receive static authentication information; and
automatically commence the continuous authentication session in response to receiving the static authentication information.

24. A mobile device comprising:
means for collecting behavioral information of a mobile device user during a continuous authentication session;
means for analyzing the behavioral information to determine a score and to generate a confidence level value based on the score; and
means for determining that the mobile device user is an authorized user of the mobile device based on the generated confidence level value.

25. The mobile device of claim 24 further comprising:
means for collecting the behavioral information in a non-secure world of a trusted execution environment (TEE);
means for collecting application identification information for a particular application corresponding to the behavioral information;
means for passing the behavioral information and the application identification information for the particular application from the non-secure world of the TEE to a secure world of the TEE; and
means for analyzing the behavioral information, corresponding to the application identification information for the particular application, in the secure world of the TEE.

26. The mobile device of claim 24 wherein the behavioral information comprises touch information.

27. The mobile device of claim 24 wherein the means for analyzing the behavioral information further comprises:
means for classifying the behavioral information;
means for extracting features of the classified behavioral information;
means for storing the extracted features in an authentication template;
means for determining an authentication template vector based on the authentication template;
means for determining the score wherein the score is an inter-vector distance between the authentication template vector and a baseline template vector, the baseline template vector being determined from a previously stored baseline template;
means for comparing the score to a score threshold value; and
means for generating the confidence level value by increasing or decreasing, as determined by the comparison, a previously determined confidence level.

28. The mobile device of claim 24 further comprising:
means for determining that the mobile device user is the authorized user of the mobile device based on the generated confidence level value being less than or equal to a confidence level threshold;
means for determining that the mobile device user is an unauthorized user of the mobile device based on the generated confidence level value being greater than the confidence level threshold; and
means for, in response to determining that the mobile device user is the unauthorized user of the mobile device, discontinuing the continuous authentication session and restricting access to the mobile device.

29. The mobile device of claim 24 further comprising means for initializing the confidence level value at a commencement of the continuous authentication session and wherein the means for analyzing the behavioral information to generate the confidence level value includes means for analyzing the behavioral information tupdate the confidence level value.

30. The mobile device of claim 24 comprising:
means for receiving static authentication information; and
means for, in response to receiving the static authentication information, automatically commencing the continuous authentication session.
